(19) United States
(12) Patent Application Publication
(10) Pub. No.: US 2015/0138487 A1
(43) Pub. Date: May 21, 2015

(54) OPTICAL MEMBER, ILLUMINATION DEVICE, AND DISPLAY DEVICE

(71) Applicant: Sharp Kabushiki Kaisha, Osaka (JP)

(72) Inventors: Yoshinobu Hirayama, Osaka (JP); Akira Imai, Osaka (JP); Shugo Yagi, Yonago-shi (JP); Toru Inata, Yonago-shi (JP); Masaki Kageyama, Yonago-shi (JP); Kazuya Hatta, Yonago-shi (JP); Masanori Ehara, Yonago-shi (JP)

(73) Assignee: Sharp Kabushiki Kaisha, Osaka (JP)

(21) Appl. No.: 14/413,669

(22) PCT Filed: Jul. 5, 2013
(86) PCT No.: PCT/JP2013/068480

§ 371 Date: Jan. 8, 2015

(30) Foreign Application Priority Data
Jul. 12, 2012 (JP) 2012-156591

(51) Int. Cl. F21V 8/00; G02F 1/1335; G02B 5/02

(52) U.S. Cl. CPC G02B 6/0051; G02B 5/0257; G02F 1/1336
USPC 349/65; 359/599; 362/606

(57) ABSTRACT

An optical sheet (optical member) includes: a sheet-shaped base material 40 that is light-transmissive; an anisotropic light condenser that is formed on the light-receiving surface of the base material where light is received, the anisotropic light condenser having light condensing anisotropy such that incident light is condensed in a light condensing direction along the light-receiving surface whereas light is not condensed in a non-light condensing direction along the light-receiving surface, the non-light condensing direction being perpendicular to the light condensing direction; and an anisotropic light scatterer that is formed on the light-emitting surface from which light is emitted, the light-emitting surface being on a side of the base material opposite to the light-receiving surface of the base member, the anisotropic light scatterer scattering and emitting light from the anisotropic light condenser, and having light scattering anisotropy where light is greatly scattered in the light condensing direction but scattered to a lesser degree in the non-light condensing direction.

### TECHNICAL FIELD

The present invention relates to an optical member, an illumination device, and a display device.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. In the liquid crystal display device, a liquid crystal panel used therein does not emit light, and therefore, it is necessary to separately provide a backlight device as an illumination device. Backlight devices are largely categorized into a direct-lighting type and an edge-lighting type depending on the mechanism thereof. Edge lit backlight devices include a light guide plate that guides light emitted from light sources disposed on the edge, and an optical member that applies optical effects on the light from the light guide plate and supply the light as even planar light to the liquid crystal panel. Among these, a turning lens type backlight device disclosed in Patent Document 1 below in which a prism sheet having prisms for condensing light is used as an optical member and the prism sheet opposes the light guide plate is known.

### RELATED ART DOCUMENTS

### Patent Documents

Patent Document 1: Japanese Patent Application Laid-Open Publication No. 2005-38863

### Problems to be Solved by the Invention

In the turning lens type backlight device, light from the light guide plate efficiently travels towards the front due to the prisms, and excellent front luminance can be attained. On the other hand, there was a tendency for the light emitted by the backlight device to gather excessively towards the front, which can narrow the effective viewing angle of the liquid crystal panel.

### SUMMARY OF THE INVENTION

The present invention was completed in view of such a situation, and an object thereof is to mitigate directionality that can occur in emitted light while maintaining the front luminance of the light at a high level.

### Means for Solving the Problems

An optical member of the present invention includes: a sheet-shaped base member that is light-transmissive; an anisotropic light condenser formed on a light-receiving surface of the base member that receives light, the anisotropic light condenser having light condensing anisotropy such that the received light is condensed in a light condensing direction along the light-receiving surface but the received light is not condensed in a non-light condensing direction along the light-receiving surface and perpendicular to the light condensing direction; and an anisotropic light scatterer formed on a light-emitting surface of the base material from which light is emitted, the light-emitting surface being opposite to the light-receiving surface, the anisotropic light scatterer scattering and emitting light from the anisotropic light condenser, and having light scattering anisotropy such that the light is scattered to a greater degree in the light condensing direction but the light is scattered to a lesser degree in the non-light condensing direction.

In this manner, light received by the light-receiving surface of the sheet-shaped base member is condensed in the light condensing direction by the anisotropic light condenser having light condensing anisotropy, but not condensed in the non-light condensing direction. The light that has passed through the base member from the anisotropic light condenser and reaches the anisotropic light scatterer formed on the light-emitting surface is scattered and emitted by the anisotropic light scatterer. The anisotropic light scatterer has light scattering anisotropy such that the amount of scattering is relatively high in the light condensing direction but relatively low in the non-light condensing direction, and thus, scattering of light condensed by the anisotropic light condenser is encouraged, and scattering of light that has not been condensed by the anisotropic light condenser is mitigated. By condensing light in the light condensing direction using the anisotropic light condenser in this manner, it is possible to increase the front luminance of light emitted by the optical member, and to alleviate directivity that can occur in light using the light scattering anisotropy of the anisotropic light scatterer.

As embodiments of the optical member the present invention, the following configurations are preferred.

(1) The anisotropic light scatterer includes a plurality of ridges aligned in the light condensing direction, the ridges protruding from the light-emitting surface and each having a substantially mountain shape in a cross-sectional view along the light condensing direction, the ridges extending in a meandering fashion in the non-light condensing direction. In this manner, the ridges of the anisotropic light scatterer have a substantially mountain shape in a cross-sectional view taken in the light condensing direction, and thus, light emitted from the inclined face at an angle based on the vertex angle generally travels in the light condensing direction. As a result, the amount of light emitted from the ridges in the light condensing direction is greater than the amount of light emitted in the non-light condensing direction. Furthermore, the ridges meander while extending in the non-light condensing direction, and the inclined faces have a meandering shape, and thus, the direction of light outputted from the inclined face varies depending on the position in the non-light condensing direction. As a result, light generally emitted in the light condensing direction from the ridges is appropriately scattered. Thus, the anisotropic light scatterer has light scattering anisotropy such that the amount of light scattered in the light condensing direction is relatively large and the amount of light scattered in the non-light condensing direction is relatively small.

(2) The plurality of ridges aligned in the light condensing direction are formed so as to meander randomly along the non-light condensing direction. In this manner, light emitted from the respective inclined faces of the ridges is scattered randomly based on the meandering shape of the ridges. As a result, even when a display panel having pixels arranged in a periodic fashion, for example, opposes the light emitting side of the optical member, interference is less likely to occur between the array of pixels and the array of ridges of the anisotropic light scatterer, and thus, a moiré pattern (interference pattern) is suppressed in the display panel.

(3) The ridges are formed such that at least one of a width and a height thereof varies randomly depending on a position in the non-light condensing direction. In this manner, in the ridges, the angle of the vertex and the direction of the inclined face vary depending on the position in the non-light condensing direction, and thus, the light outputted from the inclined face is randomly scattered. As a result, even when a display panel having pixels arranged in a periodic fashion, for example, opposes the light emitting side of the optical member, interference is less likely to occur between the array of pixels and the array of ridges of the anisotropic light scatterer, and thus, a moiré pattern (interference pattern) is suppressed in the display panel.

(4) The base member is formed in a sheet shape by biaxially stretching a thermoplastic resin material whereas the anisotropic light condenser and the anisotropic light scatterer are formed by radiating light to cure photocurable resin materials disposed to be in contact with respective surfaces of the base member. In this manner, the photocurable resin, which formed on the respective surfaces of the base member having a sheet shape by biaxially stretching a thermoplastic resin, is cured by being irradiated with light, thereby forming the anisotropic light condenser and the anisotropic light scatterer. Compared to a case in which the base member, the anisotropic light condenser, and the anisotropic light scatterer were made of the same thermoplastic resin, various effects such as shortened takt time for manufacturing can be attained.

(5) The anisotropic light condenser and the anisotropic light scatterer are made of ultraviolet curable resin materials. In this manner, compared to a case in which a visible light photocurable resin were used, costs associated with equipment and the like can be kept low because measures necessary to prevent unwanted curing of the ultraviolet curable resin are relatively simple. Also, the ultraviolet curable adhesive material is more quickly cured, and thus, the takt time can be even further reduced.

(6) The anisotropic light condenser includes a plurality of prisms aligned in the light condensing direction, the prisms protruding from the light-receiving surface and each having a substantially mountain shape in a cross-sectional view along the light-condensing direction, the prisms extending in a straight line in the non-light condensing direction. In this manner, the prisms of the anisotropic light condenser have a substantially mountain shape in a cross-sectional view along the light condensing direction, and thus, when the light entering the prisms hits the inclined face, the direction of the light is given an angle based on the vertex angle of the prism and then travels towards the front. As a result, the light is condensed as it travels in the light condensing direction from the prisms towards the base member. On the other hand, the prisms extend in a straight line along the non-light condensing direction, and thus, light traveling from the prisms towards the base member in the non-light condensing direction is not condensed.

(7) The anisotropic light scatterer includes a plurality of microlenses arranged in the non-light condensing direction and the light condensing direction, the microlenses protruding from the light-emitting surface of the base member and each having a substantially elliptical shape in a plan view with long axis direction thereof matching the non-light condensing direction and a short axis direction thereof matching the light condensing direction. In this manner, the microlenses of the anisotropic light scatterer are substantially elliptical in a plan view with the non-light condensing direction being the long axis direction and the light condensing direction being the short axis direction, and thus, the amount of light emitted in the light condensing direction is greater than the amount of light emitted in the non-light condensing direction. By the anisotropic light scatterer being configured such that the plurality of microlenses are arranged in the non-light condensing direction and the light condensing direction, the anisotropy of light emitted from the microlenses is maintained while appropriately scattering the light.

(8) The plurality of microlenses are formed such that at least one of a plan view size and a height thereof is set randomly. In this manner, the microlenses have at least one of the plan view size and the height randomized, and therefore, the light can be scattered randomly by the microlenses. As a result, even when a display panel having pixels arranged in a periodic fashion, for example, opposes the light emitting side of the optical member, interference is less likely to occur between the array of pixels and the array of microlenses of the anisotropic light scatterer, and thus, a moiré pattern (interference pattern) is suppressed in the display panel.

(9) The base member, the anisotropic light condenser and the anisotropic light scatterer are formed integrally of a thermoplastic resin material. In this manner, when mass producing the optical members, variation in polarizing state that can occur when light is transmitted through the base member is unlikely compared to a case in which the base member is formed by biaxially stretching a thermoplastic resin and forming the anisotropic light condenser and the anisotropic light scatterer, made of a different material from the base member, on each surface of the base member. As a result, the optical characteristics of light emitted from the optical member can be made stable.

Next, in order to solve the above-mentioned problem, an illumination device according to the present invention includes: the above-mentioned optical member; a light source; and a light guide plate having a light-receiving face into which light from the light source enters, and a light-emitting surface from which light is emitted, the light-emitting surface facing the light-receiving surface of the optical member.

According to the illumination device having such a configuration, light from the light source is radiated to the light-receiving face of the light guide plate, is propagated through the light guide plate, and then emitted from the light-emitting surface, thereby being emitted to the light-receiving surface of the optical member. Because the light emitted from the optical member has a high front luminance while the directivity thereof is alleviated, the light emitted by the illumination device has a high front luminance with the directivity thereof being alleviated, and thus, uneven luminance is made unlikely.

The anisotropic light condenser has a plurality of prisms aligned in a direction of alignment of the light source and the light guide plate, the prisms being formed on the light-receiving surface of the optical member and each having a substantially mountain shape with a pair of inclined faces in a cross-sectional view along said direction of alignment, the prisms extending in a straight line along a direction perpendicular to the direction of alignment, and of the pair of inclined faces of each of the prisms, an inclined face opposite to the inclined face towards the light source is a curve or a polygonal line in a cross-sectional view.

In this manner, light traveling from the light-emitting surface of the light guide plate towards the light-receiving surface of the optical member is generally inclined with respect to the light-emitting surface, and includes a component in a direction normal to the light-emitting surface and a component in a direction from the light source towards the light-receiving face of the light guide plate. As a countermeasure, the anisotropic light condenser forms substantially mountain shapes in a cross-sectional view taken along the direction in which the light source and the light guide plate are aligned with respect to each other, each of the mountain shapes having a pair of inclined faces. Of the pair of inclined faces, the inclined face that is opposite to the inclined face towards the light source is a curve or polygonal line in a cross-sectional view, and thus, light entering the prism along the direction of travel of light mentioned above can be efficiently redirected towards the front. As a result, it is possible to effectively improve front luminance. A polygonal line as mentioned here is a line in which two or more inclined lines having different angles of inclination are connected together.

In order to solve the above-mentioned problem, a display device according to the present invention includes: the above-mentioned illumination device; and a display panel that performs display using light from the illumination device.

According to the display device configured in this manner, the front luminance of light emitted by the illumination device is high and unevenness in the luminance is unlikely, and thus, high display quality can be attained.

Examples of the display panel can include a liquid crystal panel. Such a display device can be applied as a liquid crystal display device to various applications such as displays for smartphones and tablet PCs, for example.

### Effects of the Invention

According to the present invention, it is possible to mitigate directionality of emitted light while maintaining the front luminance thereof at a high level.

### BRIEF DESCRIPTION OF THE DRAWINGS

FIG. 1 is an exploded perspective view schematically showing a liquid crystal display device according to Embodiment 1 of the present invention.

FIG. 2 shows a cross-sectional configuration of the liquid crystal display device along the shorter side direction.

FIG. 3 shows a cross-sectional configuration of the liquid crystal display device along the longer side direction.

FIG. 4 is an enlarged cross-sectional view of the vicinity of an LED.

FIG. 5 is a plan view that schematically shows an arrangement of pixels in the liquid crystal panel.

FIG. 6 is a bottom view that schematic shows an arrangement of prisms that constitute an anisotropic light condenser of an optical sheet.

FIG. 7 is a plan view that schematically shows an arrangement of ridges constituting an anisotropic light scatterer in the optical sheet.

FIG. 8 is a cutout perspective view of the optical sheet.

FIG. 9 is a cross-sectional view of the optical sheet and the light guide plate along the X axis direction.

FIG. 10 is a cross-sectional view of the optical sheet and the light guide plate along the X axis direction but in a position different from that of FIG. 9 in the Y axis direction.

FIG. 11 is a graph showing a luminance distribution of light emitted by a backlight device (prism sheet) of a comparison example.

FIG. 12 is a graph showing a luminance distribution of light emitted by a backlight device (optical sheet) of a working example.

FIG. 13 is a plan view that schematically shows an arrangement of microlenses constituting an anisotropic light scatterer in an optical sheet according to Embodiment 2 of the present invention.

FIG. 14 is a cutout perspective view of the optical sheet.

FIG. 15 is a cross-sectional view of the optical sheet and the light guide plate along the X axis direction.

FIG. 16 is a cross-sectional view of an optical sheet and a light guide plate according to Embodiment 3 of the present invention, taken along the X axis direction.

FIG. 17 is a cross-sectional view of an optical sheet and a light guide plate according to Embodiment 4 of the present invention, taken along the X axis direction.

FIG. 18 is a cutout perspective view of the optical sheet according to Embodiment 3 of the present invention.

### DETAILED DESCRIPTION OF EMBODIMENTS

### Embodiment 1

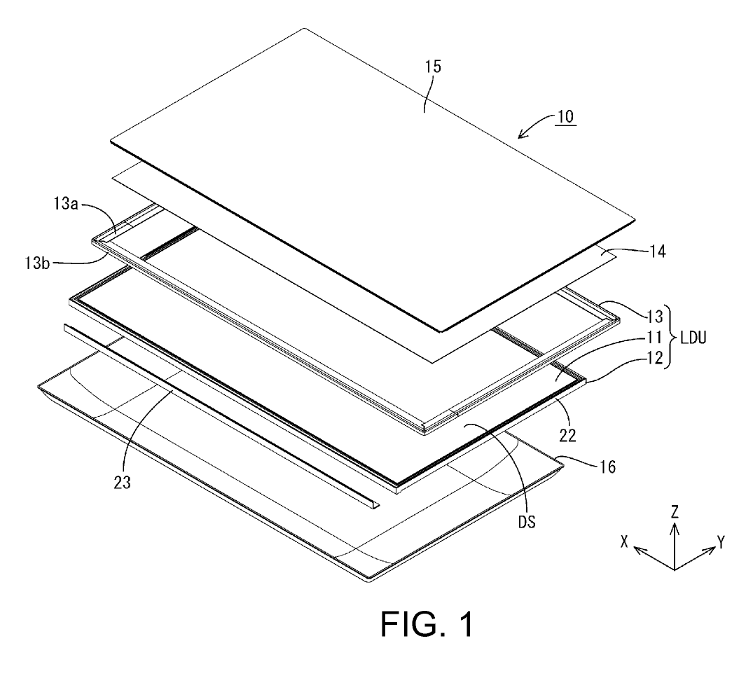

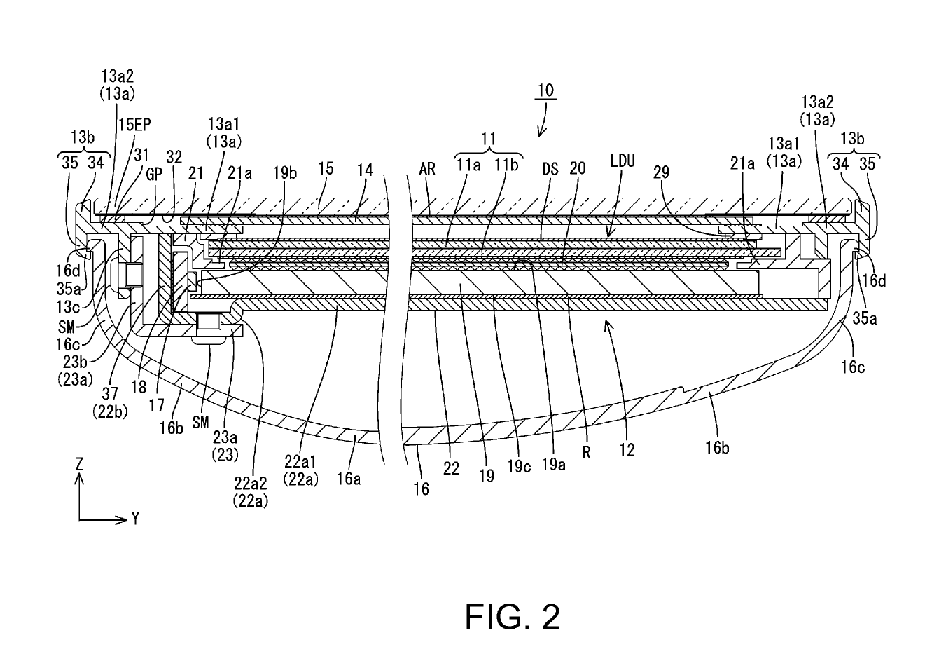

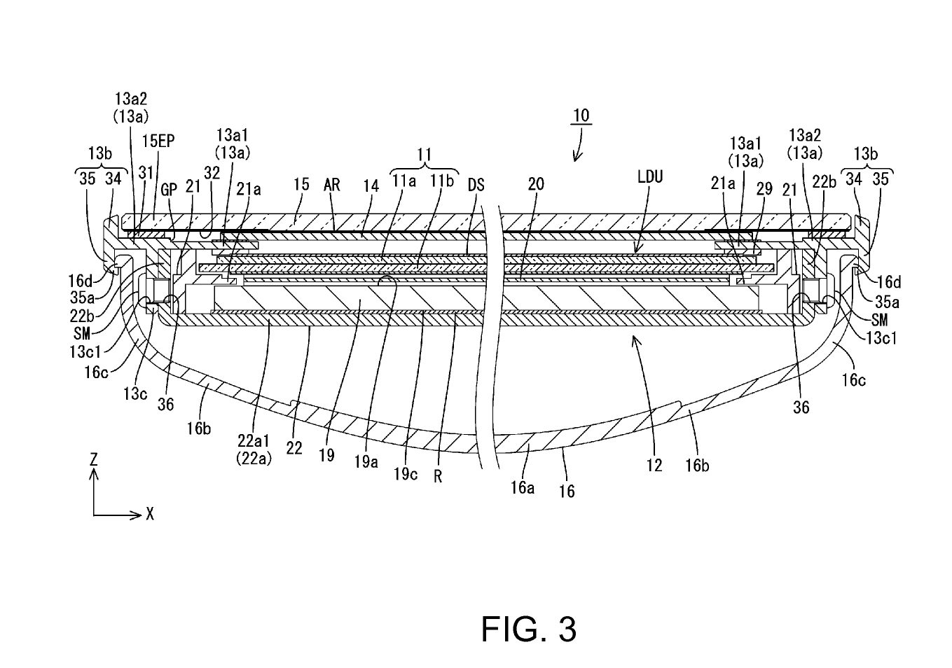

Embodiment 1 of the present invention will be described with reference to FIGS. 1 to 12. In the present embodiment, a liquid crystal display device 10 will be described as an example. The drawings indicate an X axis, a Y axis, and a Z axis in a portion of the drawings, and each of the axes indicates the same direction for the respective drawings. The upward direction in FIGS. 2 and 3 is defined as the front and the downward direction of the same drawings is defined as the rear.

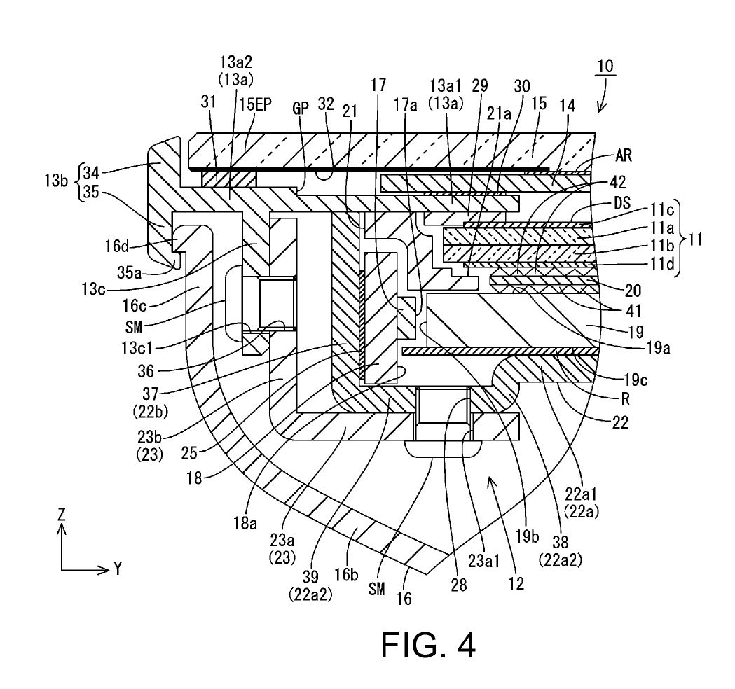

As shown in FIG. 1, the liquid crystal display device 10 is formed in a horizontally long quadrilateral shape overall, and is made by assembling together parts such as a touch panel 14, a cover panel 15 (protective panel, cover glass), and a casing 16 on a liquid crystal display unit LDU, which is the main part. The liquid crystal display unit LDU has a liquid crystal panel 11 (display panel) having a display surface DS on the front that displays images, a backlight device 12 (illumination device) that is disposed to the rear of the liquid crystal panel 11 and radiates light towards the liquid crystal panel 11, and a frame 13 (case member) that presses the liquid crystal panel 11 from the front, or in other words from the side opposite to the backlight device 12 (from the display panel DS side). The touch panel 14 and the cover panel 15 are housed within the frame 13 of the liquid crystal display unit LDU from the front, and the outer portions (including the outer edges) are received by the frame 13 from the rear. The touch panel 14 is disposed to the front of the liquid crystal panel 11 at a prescribed gap therefrom, and the rear surface (inner surface) thereof opposes the display surface DS. The cover panel 15 covers the touch panel 14 from the front, and the rear surface (inner surface) of the cover panel 15 opposes the front surface of the touch panel 14. An antireflective film AR is interposed between the touch panel 14 and the cover panel 15 (see FIG. 4). The casing 16 is assembled to the frame 13 to cover the liquid crystal display unit LDU from the rear. Of the components of the liquid crystal display device 10, a portion of the frame 13 (looped portion 13b described later), the cover panel 15, and the casing 16 constitute the outer appearance of the liquid crystal display device 10. The liquid crystal display device 10 of the present embodiment is used mainly used in tablet PCs among other electronic devices, and the display size thereof is approximately 20 inches, for example.

First, the liquid crystal panel 11 included in the liquid crystal display unit LDU will be described in detail. As shown in FIGS. 2 and 3, the liquid crystal panel 11 includes a pair of almost transparent glass substrates 11a and 11b having excellent light-transmissive qualities and having a horizontally long quadrilateral shape, and a liquid crystal layer (not shown) including liquid crystal molecules, which are a substance that changes optical properties in response to an applied electric field, the liquid crystal layer being interposed between the substrates 11a and 11b, and the substrates 11a and 11b are bonded together by a sealing member (not shown) maintaining a gap at a width equal to the thickness of the liquid crystal layer. The liquid crystal panel 11 has a display region where images are displayed (central portion surrounded by a surface light-shielding layer 32) and a non-display region surrounding the display region in a frame shape where images are not displayed (outer periphery overlapping the surface light-shielding layer 32 to be described later). The longer side direction of the liquid crystal panel 11 matches the X axis direction, the shorter side direction thereof matches the Y axis direction, and the thickness direction thereof matches the Z axis direction.

Of the two substrates 11a and 11b, one on the front side (front surface side) is a CF substrate 11a, and the other on the rear side (rear surface side) is an array substrate 11b. A plurality of TFTs (thin film transistors), which are switching elements, and a plurality of pixel electrodes are provided on the inner surface of the array substrate 11b (surface facing the liquid crystal layer and opposing the CF substrate 11a), and gate wiring lines and source wiring lines surround each of these TFTs and pixel electrodes to form a grid pattern. Each of the wiring lines is fed a prescribed image signal from control circuits, which are not shown. The pixel electrode, which is disposed in a quadrilateral region surrounded by the gate wiring lines and source wiring lines, is a transparent electrode made of ITO (indium tin oxide) or ZnO (zinc oxide).

The CF substrate 11a has formed thereon a plurality of color filters in positions corresponding to the pixels. The color filters are arranged such that the three colors R, G, and B are alternately disposed. A light-shielding layer (black matrix) is formed between the color filters to prevent color mixing. An opposite electrode is provided on the surfaces of the color filters and the light-shielding layer so as to face the pixel electrodes on the array substrate 11b. The CF substrate 11a is formed to be slightly smaller than the array substrate 11b. Alignment films for aligning the liquid crystal molecules included in the liquid crystal layer are respectively formed on the inner surfaces of the substrates 11a and 11b. Polarizing plates 11c and 11d are respectively bonded to the outer surfaces of the substrates 11a and 11b (see FIG. 4).

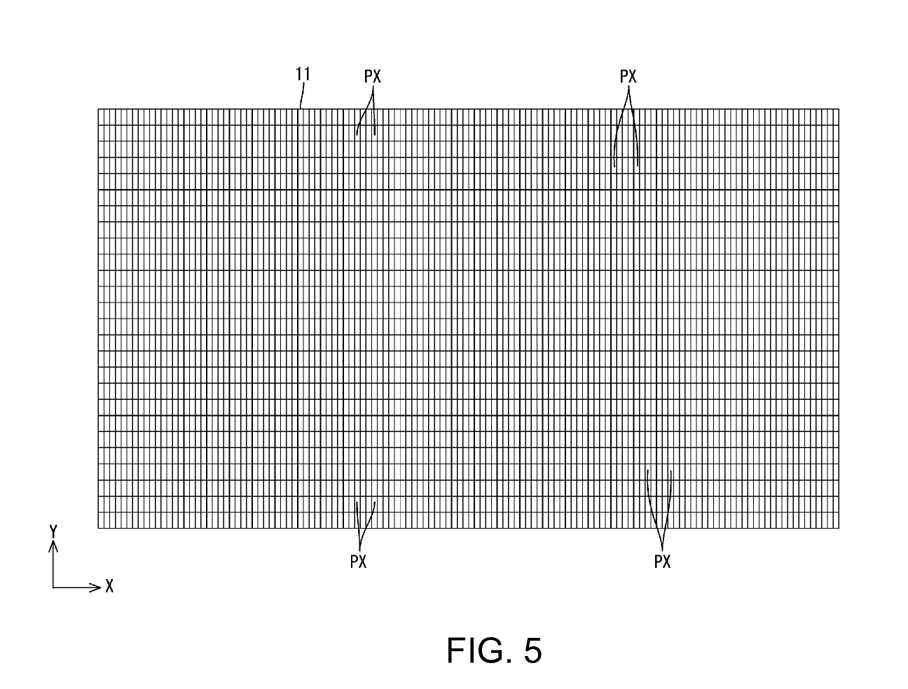

In the liquid crystal panel 11, one unit pixel PX, which is a display unit, is constituted of three colored portions of R (red), G (green), and B (blue), and three pixel electrodes respectively opposing these colored portions. As shown in FIG. 5, a plurality of these unit pixels PX are arranged in a matrix along the surfaces of the substrates 11a and 11b, or in other words, along the display surface DS (X axis direction and Y axis direction). The unit pixel PX includes a red pixel having an R colored portion, a green pixel having a G colored portion, and a blue pixel having a B colored portion. The pixels of the respective colors are repetitively arranged along the row direction (X axis direction of the surface of the liquid crystal panel 11, forming a group of pixels, and a plurality of the groups of pixels are arranged along the column direction (Y axis direction). Thus, the unit pixels PX are periodic structures that are arranged such that a plurality thereof are disposed along the X axis direction and the Y axis direction in a periodic manner. FIG. 5 schematically shows an example of an arrangement of unit pixels PX in the liquid crystal panel 11.

Next, the backlight device 12 included in the liquid crystal display unit LDU will be described in detail. As shown in FIG. 1, the backlight device 12 overall has a substantially block shape that is long in the horizontal direction in a manner similar to the liquid crystal panel 11. As shown in FIGS. 3 and 4, the backlight device 12 includes LEDs 17 (light-emitting diodes), which are light sources, an LED substrate 18 (light source substrate) on which the LEDs 17 are mounted, a light guide plate 19 that guides light from the LEDs 17, an optical sheet 20 (optical member) stacked over the light guide plate 19, a light-shielding frame 21 that presses the light guide plate 19 from the front, a chassis 22 that houses the LED substrate 18, the light guide plate 19, the optical sheet 20, and the light-shielding frame 21, and a heat-dissipating member 23 attached so as to be in contact with the outer surface of the chassis 22. The backlight device 12 has LEDs 17 (LED substrate 18) disposed along one longer side among the outer edges of the backlight device 12, and is of a single-side lit edge lit type (side lit type).

As shown in FIGS. 2 and 4, each LED 17 has a configuration in which an LED chip is sealed by a resin material onto a portion of the LED substrate 18 where the LED 17 is to be bonded. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chip and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. The LEDs 17 are of a so-called top-type in which the side opposite to that mounted onto the LED substrate 18 is a light-emitting surface 17a.

As shown in FIGS. 2 and 4, the LED substrate 18 has a long plate shape that extends in the X axis direction (longer side direction of light guide plate 19 and chassis 22), and is housed in the chassis 22 such that the surface thereof is parallel to the X axis direction and the Z axis direction, or in other words, perpendicular to the surfaces of the liquid crystal panel 11 and the light guide plate 19. In other words, the LED substrates 18 are disposed such that the longer side direction of the surface thereof is the same as the X axis direction, the shorter side direction of the surface thereof is the same as the Z axis direction, and the substrate thickness direction perpendicular to the surface is the same as the Y axis direction. The LED substrate 18 is disposed such that the inner surface thereof (mounting surface 18a) faces one edge face (light-receiving face 19b) of the light guide plate 19 with a prescribed gap in the Y axis direction therefrom. Therefore, the direction in which the LEDs 17, the LED substrate 18, and the light guide plate 19 are aligned substantially matches the Y axis direction. The longer dimension of the LED substrate 18 substantially matches the longer dimension of the light guide plate 19, and the LED substrate 18 is attached to one longer edge of the chassis 22 to be described later.

As shown in FIG. 4, the LEDs 17 having the configuration above are mounted on the inner surface of the LED substrate 18, or in other words, the surface facing the light guide plate 19 (surface opposing the light guide plate 19), and this surface is the mounting surface 18a. A plurality of the LEDs 17 are disposed in a row (in a line) at a gap therebetween in the length direction (X axis direction) on the mounting surface 18a of the LED substrate 18. In other words, the plurality of LEDs 17 are disposed intermittently along the longer side direction on one longer side of the backlight device 12. Also, the mounting surface 18a of the LED substrate 18 has formed thereon a wiring pattern (not shown) made of a metal film (copper foil or the like) that extends in the X axis direction across the group of LEDs 17 so as to connect adjacent LEDs 17 in series. Terminal portions formed on either side of the wiring pattern are connected to an LED driver circuit such that driving power can be supplied to the respective LEDs 17. Also, the base member of the LED substrate 18 is made of metal like the chassis 22, and the wiring pattern (not shown) is formed on the LED substrate 18 across an insulating layer. It is also possible to form the base member of the LED substrate 18 of an insulating material such as a ceramic.

As shown in FIGS. 2 and 3, the light guide plate 19 is made of a synthetic resin (such as acrylic) having an index of refraction sufficiently greater than that of air and being almost transparent (having excellent light transmission). Like the liquid crystal panel 11, the light guide plate 19 is formed in a horizontally long flat plate as seen in a plan view, and the surface of the light guide plate 19 is parallel to the surface of the liquid crystal panel 11 (display surface DS). The light guide plate 19 is disposed such that the longer side direction of the surface thereof matches the X axis direction, the shorter side direction matches the Y axis direction, and the thickness direction perpendicular to the plate surface thereof matches the Z axis direction. The light guide plate 19 is disposed in the chassis 22 directly below the liquid crystal panel 11 and the optical sheet 20, and one of the longer sides of the outer edge faces opposes the LEDs 17 on the LED substrate 18 disposed on one of the longer sides of the chassis 22. Thus, the LEDs 17 (LED substrate 18) and the light guide plate 19 are arranged in the Y axis direction with respect to each other whereas the optical sheet 20 (liquid crystal panel 11) and the light guide plate 19 are arranged (stacked) in the Z axis direction with respect to each other, and the two directions are perpendicular to each other. The light guide plate 19 has the function of receiving light emitted by the LEDs 17 towards the light guide plate 19 in the Y axis direction (direction in which the LEDs 17 are aligned with respect to the light guide plate 19) at the longer side edge face thereof, and propagating this light therein and causing the light to be emitted upward from the surface thereof towards the optical sheet 20 (front, light-emission side).

Of the surfaces of the plate-shaped light guide plate 19, the front surface (surface facing the liquid crystal panel 11 and the optical sheet 20) is, as shown in FIGS. 2 and 3, the light-emitting surface 19a from which internal light is emitted towards the optical sheet 20 and the liquid crystal panel 11. Of the outer edge faces adjacent to the plate surface of the light guide plate 19, one of the pair of edges faces having an elongated shape in the X axis direction (direction in which the LEDs 17 are aligned; longer side direction of the LED substrate 18) faces the LEDs 17 (LED substrate 18) at a prescribed gap therefrom as shown in FIG. 4, and this is the light-receiving face 19b into which light emitted from the LEDs 17 enters. The light-receiving face 19b is on a plane parallel to that defined by the X axis and the Z axis, and is substantially perpendicular to the light-emitting surface 19a. The direction along which the LEDs 17 and the light-receiving faces 19b (light guide plate 19) are aligned with respect to each other is the same as the Y axis direction, and is parallel to the light-emitting surface 19a. Of the outer edge faces of the light guide plate 19, the three edge faces other than the light-receiving face 19b and specifically the longer edge face opposite to the light-receiving face 19b and the pair of shorter edge faces are, as shown in FIGS. 2 and 3 non-LED-facing edge faces (non-light source-facing edge faces) that do not face the LEDs 17.

Of the surfaces of the light guide plate 19, a surface 19c opposite to the light-emitting surface 19a is, as shown in FIGS. 2 and 3, entirely covered by a reflective sheet R that can reflect light in the light guide plate 19 back towards the front. In other words, the reflective sheet R is sandwiched between a bottom plate 22a of the chassis 22a and the light guide plate 19. As shown in FIG. 5, the edge of the reflective sheet R at the light-receiving face 19b of the light guide plate 19 extends farther outward than the light-receiving face 19b, or in other words, towards the LEDs 17, and this extended portion reflects light from the LEDs 17, thereby allowing the light-receiving efficiency of the light-receiving face 19b to be improved. At least one of the light-emitting surface 19a and the surface 19c opposite thereto in the light guide plate 19, or the surface of the reflective sheet R has a scattering portion (not shown) that scatters light inside the light guide plate 19, the scattering portion having a pattern to have a prescribed planar distribution, and as a result, light emitted from the light-emitting surface 19a is controlled to have an even planar distribution.

As shown in FIGS. 2 and 3, the optical sheet 20 is a horizontally long quadrilateral in a plan view, as in the liquid crystal panel 11 and the chassis 22. The optical sheet 20 is placed on the light-emitting surface 19b of the light guide plate 19, and are interposed between the liquid crystal panel 11 and the light guide plate 19, thus allowing light emitted from the light guide plate 19 therethrough while applying prescribed optical effects thereon, and emitting the light to the liquid crystal panel 11. Detailed configurations, functions, and the like of the optical sheet 20 will be described later.

As shown in FIGS. 2 and 3, a light-shielding frame 21 is formed in a substantially frame shape that extends along the outer edges of the light guide plate 19, and can press almost the entirety of the outer edges of the light guide plate 19 from the front. The light-shielding frame 21 is made of a synthetic resin, and by having the surface thereof colored black, for example, the light-shielding frame 21 has light-shielding properties. The light-shielding frame 21 has an inner edge 21a that is present in the entire area between the outer edge portion of the light guide plate 19 and the LEDs 17, and respective outer edge portions of the liquid crystal panel 11 and the optical sheet 20, thereby optically isolating them from each other. As a result, light that was emitted by the LEDs 17 but did not enter the light-receiving face 19b and light that has leaked from the edge faces of the light guide plate 19 (light-receiving face 19b and the three non-LED-facing edge faces that do not face the LEDs 17) can be prevented from directly entering the outer edge portions of the liquid crystal panel 11 and the optical sheet 20 (particularly the edge faces). The three sides of the light-shielding frame 21 that do not overlap the LEDs 17 and the LED substrate 18 in a plan view (pair of short sides and long side opposite to that facing the LED substrate 18) have a portion rising from the bottom plate 22a of the chassis 22 and a portion supporting the frame 13 from the rear, whereas the long side overlapping the LEDs 17 and the LED substrate 18 in a plan view covers the edge of the light guide plate 19 and the LED substrate 18 (LEDs 17) from the front while bridging the pair of short sides. The light-shielding frame 21 is fixed to the chassis 22 to be described next by a fixing member such as a screw member (not shown).

The chassis 22 is made of sheet metal having excellent thermal conductivity made of an aluminum plate, an electro galvanized steel sheet (SECC), or the like, and as shown in FIGS. 2 and 3, the chassis 22 has a bottom plate 22a having a horizontally long quadrilateral shape similar to the liquid crystal panel 11, and side plates 22b that rise towards the front from the respective outer edges (pair of long sides and pair of short sides) of the bottom plate 22a. In the chassis 22 (bottom plate 22a), the long side direction thereof matches the X axis direction, and the short side direction thereof matches the Y axis direction. A majority of the bottom plate 22a is a light guide plate supporting portion 22a1 that supports the light guide plate 19 from the rear (side opposite to the light-emitting surface 19a), whereas the edge thereof by the LED substrate 18 is a substrate housing portion 22a2 that protrudes in a step shape to the rear. As shown in FIG. 4, the substrate housing portion 22a2 has a substantially L shape in a cross-sectional view, and includes a rising portion 38 that bends from the edge of the light guide plate supporting portion 22a1 and extends to the rear, and a housing bottom portion 39 that is bent from the end of the rising portion 38 and protrude towards a direction opposite to the light guide plate supporting portion 22a1. The portion of the rising portion 38 that bends from the edge of the light guide plate supporting portion 22a1 is located to a side of the light-receiving face 19b of the light guide plate 19 opposite to the LEDs 17 (towards center of the light guide plate supporting portion 22a1). A longer side plate 22b rises towards the front from a bend at the protruding tip of the housing bottom portion 39. The long side plate 22b connected to the substrate housing portion 22a2 has the LED substrate 18 attached thereto, and this side plate 22b is a substrate attaching portion 37. The substrate attaching portion 37 has a surface opposing the light-receiving face 19b of the light guide plate 19, and the LED substrate 18 is attached to this opposing surface. A surface of the LED substrate 18 opposite to the mounting surface 18a to which the LEDs 17 are mounted is fixed to the inner surface of the substrate attaching portion 37 by a substrate fixing member 25 such as double-sided tape. The attached LED substrate 18 is at a small gap from the inner surface of the housing bottom portion 39 of the substrate housing portion 22a2. The rear surface of the bottom plate 22a of the chassis 22 has attached thereto a liquid crystal panel driver circuit substrate (not shown) for controlling the driving of the liquid crystal panel 11, an LED driver circuit substrate (not shown) for supplying driving power to the LEDs 17, a touch panel driver circuit substrate (not shown) for controlling the driving of the touch panel 14, and the like.

The heat-dissipating member 23 is made of sheet metal having excellent thermal conductivity such as an aluminum plate, and as shown in FIGS. 1 and 2, the heat-dissipating member 23 extends along one longer side of the chassis 22, and specifically, along the substrate housing portion 22a2, which houses the LED substrate 18. As shown in FIG. 4, the heat-dissipating member has a substantially L shape in a cross-sectional view, and includes a first heat-dissipating portion 23a that is parallel to the outer surface of the substrate housing portion 22a2 and is in contact with this outer surface, and a second heat-dissipating portion 23b that is parallel to the outer surface of the side plate 22b (substrate attaching portion 37), which is connected to the substrate housing portion 22a2. The first heat-dissipating portion 23a has a narrow plate shape extending along the X axis direction, and the surface thereof facing the front and parallel to the X axis direction and the Y axis direction abuts almost the entire length of the outer surface of the housing bottom portion 39 in the substrate housing portion 22a2. The first heat-dissipating portion 23a is screwed into the housing bottom portion 39 by a screw member SM, and has a screw insertion hole 23a1 for inserting the screw member SM. The housing bottom portion 39 has a screw hole 28 that is threaded to engage the screw member SM. As a result, heat emitted by the LEDs 17 is transmitted to the first heat-dissipating portion 23a through the LED substrate 18, the substrate attaching portion 37, and the substrate housing portion 22a2. A plurality of the screw members SM are attached to the first heat-dissipating portion 23a at a gap from each other along the extension direction thereof. The second heat-dissipating portion 23b has a narrow plate shape extending along the X axis direction and the surface thereof facing the inside and parallel to the X axis direction and the Z axis direction is arranged to oppose the substrate attaching portion 37 at a prescribed gap therefrom.

Next, the frame 13 included in the liquid crystal display unit LDU will be described. The frame 13 is made of a metal such as aluminum having an excellent thermal conductivity, and as shown in FIG. 1 has an overall horizontally long frame shape along the outer edges of the liquid crystal panel 11, the touch panel 14, and the cover panel 15. The frame 13 is formed by press working or the like. As shown in FIGS. 2 and 3, the frame 13 presses the outer edges of the liquid crystal panel 11 from the front, and sandwiches the liquid crystal panel 11, the optical sheet 20, and the light guide plate 19, which are stacked one on top of the other, with the chassis 22 of the backlight device 12. On the other hand, the frame 13 receives the outer edges of the touch panel 14 and the cover panel 15 from the rear, and is interposed between the outer edges of the liquid crystal panel 11 and the touch panel 14. As a result, a prescribed gap is set between the liquid crystal panel 11 and the touch panel 14, and when an external force acts on the cover panel 15 causing the touch panel 14 to warp towards the liquid crystal panel 11, the warped touch panel 14 is unlikely to interfere with the liquid crystal panel 11.

As shown in FIGS. 2 and 3, the frame 13 has: a frame-shaped portion 13a (main frame portion) disposed along the outer edges of the liquid crystal panel 11, the touch panel 14, and the cover panel 15; a loop portion 13b (cylindrical portion) that is connected to the outer edge of the frame-shaped portion 13a and surrounds the touch panel 14, the cover panel 15, and the casing 16 from the outside; and an attaching plate portion 13c protruding towards the rear from the frame-shaped portion 13a, the attaching plate portion 13c being attached to the chassis 22 and the heat-dissipating member 23.

As shown in FIGS. 2 and 3, the frame-shaped portion 13a has a substantially plate shape with a surface parallel to the respective surfaces of the liquid crystal panel 11, the touch panel 14, and the cover panel 15, the frame-shaped portion 13a having a horizontally long substantially quadrilateral frame shape in a plan view. In the frame-shaped portion 13a, the outer edge portion 13a2 has a greater thickness than the inner edge portion 13a1, and a step GP (gap) is formed at the boundary between the two. In the frame-shaped portion 13a, the inner edge portion 13a1 is disposed between the outer edge portion of the liquid crystal panel 11 and the outer edge portion of the touch panel 14, whereas the outer edge portion 13a2 receives the outer edge portion of the cover panel 15 from the rear. In this manner, almost the entire front surface of the frame-shaped portion 13a is covered by the cover panel 15, which means that almost none of the front surface is exposed. As a result, even if the temperature of the frame 13 increases due to heat from the LEDs 17 or the like, the user of the liquid crystal display device 10 is unlikely to directly touch the exposed portions of the frame 13, which is excellent for safety. The rear surface of the inner edge portion 13a1 of the frame-shaped portion 13a has fixed thereto a cushioning material 29 for pressing the liquid crystal panel 11 while cushioning it, whereas the front surface of the inner edge portion 13a1 has fixed thereto a first fixing member 30 for cushioning and fixing in place the outer edge portion of the touch panel 14. The cushioning material 29 and the first fixing member 30 are disposed to overlap each other in a plan view at the inner edge portion 13a1. The front surface of the outer edge portion 13a2 of the frame-shaped portion 13a has fixed thereto a second fixing member 31 for fixing in place the cover panel 15 while cushioning it. The cushioning material 29 and the fixing members 30 and 31 extend along the sides of the frame-shaped portion 13a excluding the four corners thereof. The fixing members 30 and 31 are double-sided tapes having a base member with cushioning properties, for example.

As shown in FIGS. 2 and 3, the loop portion 13b overall has a short rectangular tube shape that is horizontally long in a plan view, and includes a first loop portion 34 that protrudes towards the front from the outer edge of the outer edge portion 13a2 of the frame-shaped portion 13a, and a second loop portion 35 that protrudes towards the rear from the outer edge of the outer edge portion 13a2 of the frame-shaped portion 13a. In other words, the inner surface of the short rectangular tube shaped loop portion 13b substantially towards the center in the axis direction thereof (Z axis direction) has connected thereto the outer edge of the frame-shaped portion 13a along the entire length of the inner surface. The first loop portion 34 is disposed so as to surround the entire outer edge face of the touch panel 14 and the cover panel 15 disposed to the front of the frame-shaped portion 13a. The inner surface of the first loop portion 34 faces the outer edge faces of the touch panel 14 and the cover panel 15, whereas the outer surface thereof is exposed on the outside of the liquid crystal display device 10, and constitutes the outer appearance of the side face of the liquid crystal display device 10. On the other hand, the second loop portion 35 surrounds from the outside the front edge (attaching portion 16c) of the casing 16 disposed to the rear of the frame-shaped portion 13a. The inner surface of the second loop portion 35 faces the attaching portion 16c of the casing 16 to be described later, whereas the outer surface thereof is exposed on the outside of the liquid crystal display device 10, and constitutes the outer appearance of the side face of the liquid crystal display device 10. The protruding tip of the second loop portion 35 has a frame fixing tab 35a having a hook shape in a cross-sectional view, and by fixing the casing 16 to the frame fixing tab 35a, the casing 16 can be securely attached.

As shown in FIGS. 2 and 3, the attaching plate portion 13c protrudes from the rear of the outer edge portion 13a2 of the frame-shaped portion 13a, and has a plate shape extending along the respective sides of the frame-shaped portion 13a, the surface of the attaching plate portion 13c being substantially perpendicular to the surface of the frame-shaped portion 13a. The attaching plate portion 13c is individually provided on each side of the frame-shaped portion 13a. The attaching plate portion 13c disposed on the long side of the frame-shaped portion 13a facing the LED substrate 18 has an inner surface to which the outer surface of the second heat-dissipating portion 23b of the heat-dissipating portion 23 is attached. The attaching plate portion 13c is screwed onto the second heat-dissipating portion 23b by screw members SM, and has screw insertion holes 13c1 through which the screw members SM are inserted. The second heat-dissipating portion 23b has screw holes 36 that are threaded to engage the screw members SM. As a result, heat from the LEDs 17 transmitted from the first heat-dissipating portion 23a to the second heat-dissipating portion 23b is transmitted to the attaching plate portion 13c and then to the entire frame 13, thereby efficiently dissipating heat. The attaching plate portion 13c is fixed indirectly to the chassis 22 through the heat-dissipating portion 23. On the other hand, the attaching plate portions 13c respectively disposed on the pair of short sides and the long side opposite to that facing the LED substrate 18 are respectively screwed in by the screw members SM such that the inner surface of the attaching plate portions 13c are in contact with the outer surfaces of the side plates 22b of the chassis 22. The attaching plate portions 13c have formed therein screw insertion holes 13c1 for inserting the screw members SM therein, whereas the side plates 22b have screw holes 36 that are threaded to engage the screw members SM. A plurality of the screw members SM are attached to the attaching plate portion 13c along the extension direction thereof at a gap therebetween.

Next, the touch panel 14 attached to the frame 13 will be described. As shown in FIGS. 1 to 3, the touch panel 14 is a position input device for use by the user to input position information within the display surface DS of the liquid crystal panel 11, and the touch panel 14 has formed thereon a prescribed touch panel pattern (not shown) on a glass substrate having a horizontally long quadrilateral shape and being almost transparent with excellent light transmittance. Specifically, the touch panel 14 has a glass substrate having a horizontally long quadrilateral shape in a manner similar to the liquid crystal panel 11, and has formed thereon transparent electrodes (not shown) for the touch panel constituting a so-called projection-type capacitive touch panel pattern on the front surface thereof. A plurality of the transparent electrodes for the touch panel are arranged in a matrix on the surface of the substrate. A terminal portion (not shown) to which wiring lines drawn from the transparent electrodes for the touch panel constituting the touch panel pattern are connected is formed on one long side of the touch panel 14, and by connecting a flexible substrate (not shown) to the terminal portion, it is possible to supply a potential from the touch panel driver circuit substrate to the transparent electrodes for the touch panel constituting the touch panel pattern. The outer edge portion of the interior surface of the touch panel 14 is fixed to the inner edge portion 13a1 of the frame-shaped portion 13a of the frame 13 by the first fixing member 30 described above.

Next, the cover panel 15 attached to the frame 13 will be described. As shown in FIGS. 1 to 3, the cover panel 15 is disposed to cover almost the entire touch panel 14 from the front, thereby protecting the touch panel 14 and the liquid crystal panel 11. The cover panel 15 covers the entire frame-shaped portion 13a of the frame 13 from the front and constitutes the front outer appearance of the liquid crystal display device 10. The cover panel 15 is made of a glass plate base member that has a horizontally long quadrilateral shape and is almost transparent with excellent light transmittance, and it is preferable that the cover panel 15 be made of tempered glass. It is preferable that the tempered glass used for the cover panel 15 be a chemically strengthened glass including a chemically strengthened layer on the surface by applying a chemical strengthening treatment on the surface of a plate-shaped glass base, for example. This chemical strengthening treatment uses ion exchange to strengthen the plate-shaped glass base by substituting an alkali metal ion contained in the glass material with an alkali metal ion that has a larger ion radius. The chemically strengthened layer resulting from this treatment is a compressive strength layer (ion exchange layer) that has residual compressive stress. As a result, the cover panel 15 has a high mechanical strength and shock resistance, thereby more reliably preventing damage or scratches on the touch panel 14 and the liquid crystal panel 11 provided to the rear thereof.

As shown in FIGS. 2 and 3, the cover panel 15 has a horizontally long quadrilateral shape in a plan view, like the liquid crystal panel 11 and the touch panel 14, and the plan view size thereof is slightly larger than that of the liquid crystal panel 11 and the touch panel 14. Therefore, the cover panel 15 has a protruding portion 15EP that protrudes outward in an eve shape beyond the entire outer edge of the liquid crystal panel 11 and the touch panel 14. The protruding portion 15EP has a horizontally long substantially frame shape surrounding the liquid crystal panel 11 and the touch panel 14, and the interior surface thereof is fixed to the outer edge portion 13a2 of the frame-shaped portion 13a of the frame 13 by the second fixing member 31. On the other hand, the central portion of the cover panel 15 facing the touch panel 14 is stacked onto the front of the touch panel 14 across an antireflective film AR.

As shown in FIGS. 2 and 3, a surface light-shielding layer 32 (light-shielding layer; surface light-shielding portion) is formed on the interior (rear) surface (surface facing the touch panel 14) in the outer edge portion of the cover panel 15 including the protruding portion 15EP. The surface light-shielding layer 32 is made of a light-shielding material such as a black coating, for example, and this light-shielding material is printed onto the interior surface of the cover panel 15, and is thus integrally formed with this surface. When providing the surface light-shielding layer 32, it is possible to use printing methods such as screen printing or inkjet printing, for example. The surface light-shielding layer 32 is formed on portions overlapping the outer edge portions of the touch panel 14 and the liquid crystal panel 11 in a plan view in areas further inside the protruding portion 15EP in addition to the entire protruding portion 15EP of the cover panel 15. Thus, the surface light-shielding layer 32 is disposed to surround the display region of the liquid crystal panel 11, which allows light outside the display region to be blocked, thereby allowing for a high display quality for images displayed in the display region.

Next, the casing 16 attached to the frame 13 will be described. The casing 16 is made of a synthetic resin or a metal, and as shown in FIGS. 1 to 3, has a substantially bowl shape open towards the front, covers members such as the frame-shaped portion 13a of the frame 13, the attaching plate portion 13c, the chassis 22, and the heat-dissipating portion 23, and constitutes the rear outer appearance of the liquid crystal display device 10. The casing 16 has a relatively flat bottom portion 16a, a curved portion 16b that rises from the outer edges of the bottom portion 16a while having a curved shape in a cross-sectional view, and an attaching portion 16c that rises substantially vertically from the outer edge of the curved portion 16b towards the front. The attaching portion 16c has a casing fixing tab 16d having a hook shape in a cross-sectional view, and the casing fixing tab 16d engages the frame fixing tab 35a of the frame 13, thereby securely attaching the casing 16 to the frame 13.

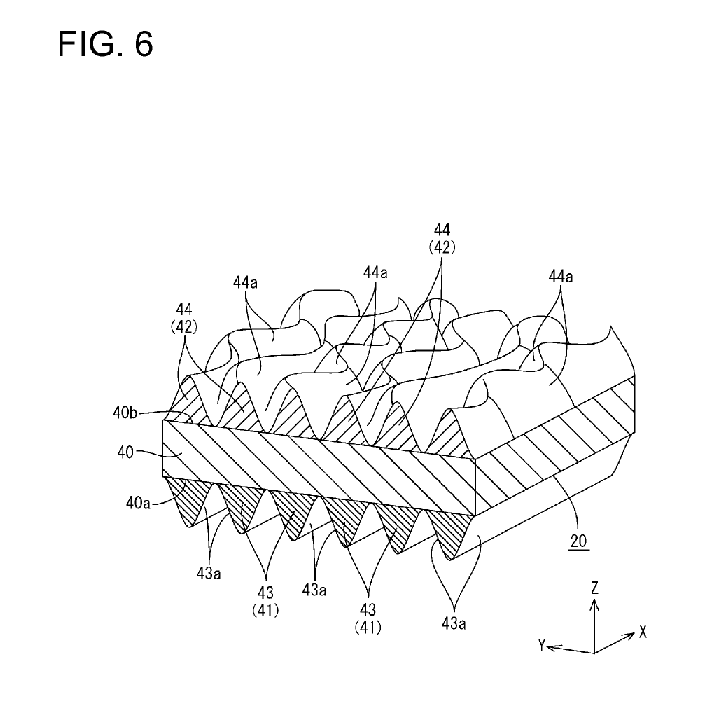

The optical sheet 20 will be described in detail here. The optical sheet 20 applies a prescribed light condensing effect on light outputted from the light guide plate 19 and then applies a prescribed scattering effect, thereby increasing the front luminance of output light supplied to the liquid crystal panel 11 and alleviating directivity that can occur in the outputted light. As shown in FIG. 6, the optical sheet 20 includes a base member 40 having a sheet shape of a prescribed thickness, an anisotropic light condenser 41 that is formed on a light-receiving surface 40a of the base member 40 to which light from the light guide plate 19 is radiated and that has light-condensing anisotropy, and an anisotropic light scatterer 42 that is formed on a light-emitting surface 40b of the base member 40 from which light is radiated towards the liquid crystal panel 11 and that has light-scattering anisotropy.

As shown in FIG. 6, the base member 40 has a substantially transparent (having light transmitting properties) sheet shape and is made of a thermoplastic resin such as PET. The base member 40 is formed by forming a thermoplastic resin to be the base member 40 into a film of a prescribed thickness and then biaxially stretched along the X axis direction and the Y axis direction in a high temperature environment. The formed base member 40 has thermoplastic resin molecules oriented in the extension direction during the manufacturing process (X axis direction and Y axis direction), which allows for greater strength and greater thermal durability.

As shown in FIGS. 6, 7, and 9, the anisotropic light condenser 41 is the rear surface of the base member 40 and is integrally formed on the light-receiving surface 40a to which light is radiated from the light-emitting surface 19a, the anisotropic light condenser 41 being formed to face the light-emitting surface 19a of the light guide plate 19. The anisotropic light condenser 41 is made of an almost transparent ultraviolet curable resin, which is a type of photocurable resin. The ultraviolet curable resin has an almost transparent resin such as an acrylic resin as the main material, for example, the resin having the property of being cured (having an increase in viscosity) by being irradiated with ultraviolet light (UV light), the resin having an index of refraction higher than air and being substantially the same as that of the light guide plate 19. With regard to manufacturing, a not yet cured ultraviolet curable resin is filled into a mold and the base member 40 is placed on the opening of that mold, thereby placing the ultraviolet curable resin, which has not yet been cured, in contact with the light-receiving surface 40a, and irradiating the ultraviolet curable resin with ultraviolet light through the substrate 40 in this state to cure the ultraviolet curable resin and form the anisotropic light condenser 41.

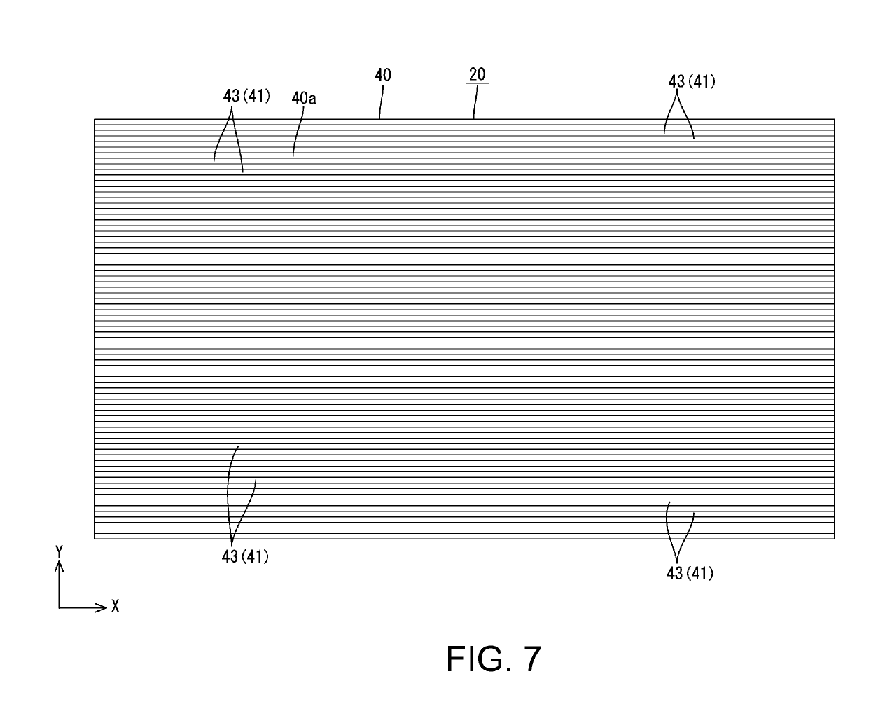

As shown in FIGS. 6, 7, and 9, the anisotropic light condenser 41 includes a plurality of prisms 43 that protrude towards the rear (towards the light guide plate 19) in the Z axis direction from the light-receiving surface 40a of the base member 40. The prisms 43 extend in a line along the X axis direction while forming a substantially mountain shape in a cross-sectional view along the Y axis direction, and a plurality of these prisms 43 are arranged in the Y axis direction on the light-receiving surface 40a. Each prism 43 has a substantially isosceles triangular shape in a cross-sectional view, the prism 43 having a pair of inclined faces 43a leading to a vertex. The vertex of the prism 43 is at an acute angle, and each inclined face 43a is at an incline with respect to the Y axis direction and the Z axis direction, the inclined face 43a extending along the X axis direction while maintaining a constant angle of incline. Thus, at any position in the X axis direction, which is the extension direction of the prism 43, the angle of incline of the inclined faces 43a is constant. The plurality of prisms 43 arranged in the Y axis direction all have substantially the same vertex angle, bottom side width, and height, and gaps between adjacent prisms 43 are also substantially the same, and thus, the prisms 43 are disposed at an even interval. FIG. 7 schematically shows an example of an arrangement of prisms 43 on the optical sheet 20.

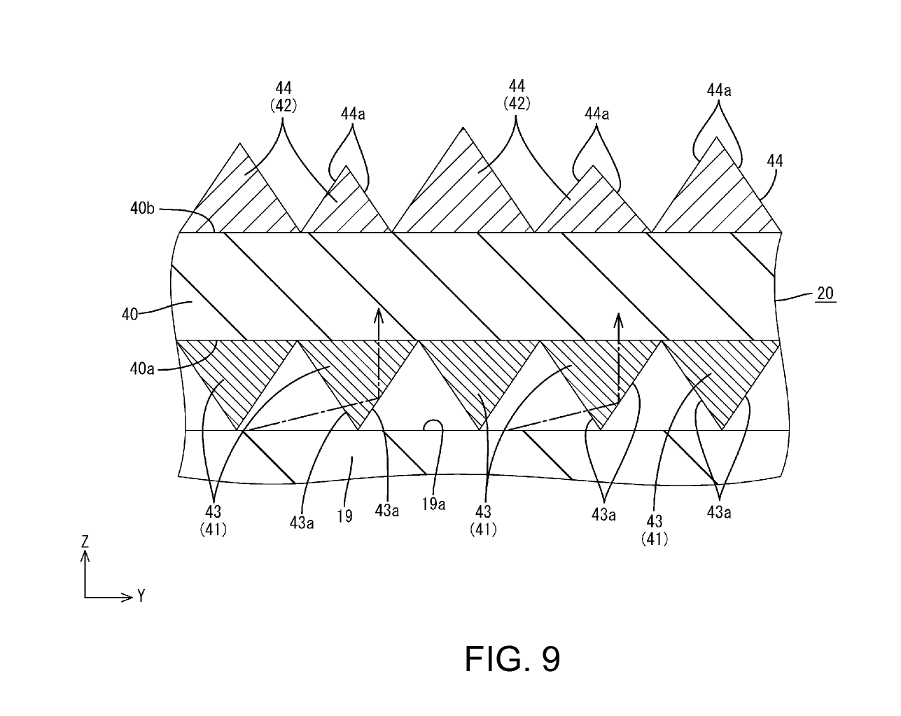

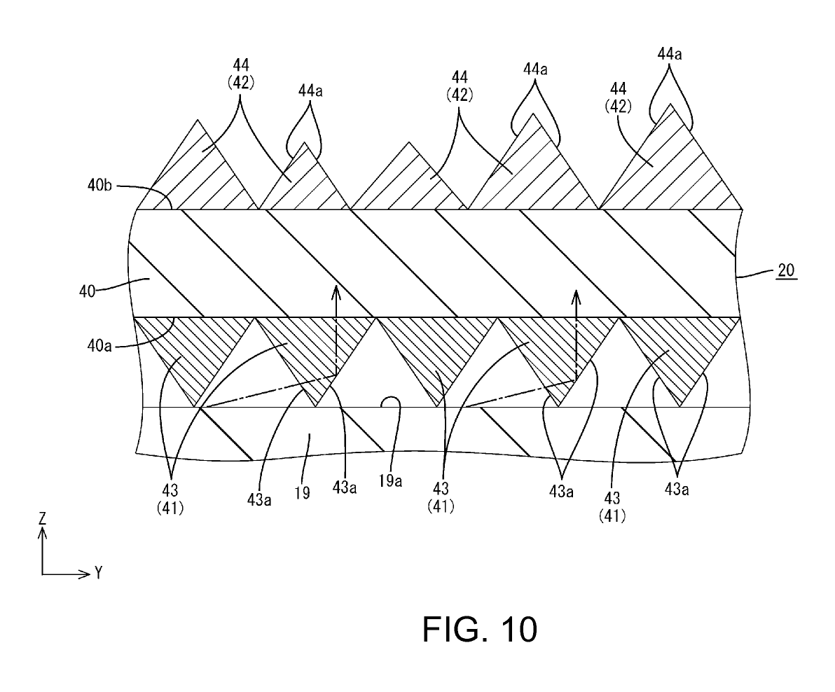

If light is radiated from the light guide plate 19 to the prisms 43 configured in this manner, then as shown in FIGS. 9 and 10, the light radiated into the prisms 43 is refracted at the boundary between the inclined face 43a and the air layer, which allows light to be radiated towards the front (in a direction normal to the surfaces 40a and 40b of the base member 40). A large portion of the light propagated through the light guide plate 19 and light emitted from the light-emitting surface 19a travels in a direction from the LEDs 17 towards the light guide plate 19 (towards the right in the Y axis direction in FIG. 4), and by causing such light to be efficiently raised by the prisms 43 towards the front allows front luminance of light supplied from the optical sheet 20 to the liquid crystal panel 11 to be improved. Such light-condensing effects are applied on light entering the prisms 43 in the Y axis direction, or in other words, the direction in which the LEDs 17 and the light guide plate 19 are aligned, but light entering the prisms 43 in the X axis direction, which is perpendicular to the Y axis direction, is mostly unaffected. Thus, the anisotropic light condenser 41 of the present embodiment has a light-condensing direction in which light-condensing effects are applied on the light as the Y axis direction, which is the direction in which the plurality of prisms 43 are aligned, whereas the X axis direction, which is the extension direction of the prisms 43 is the non-light-condensing direction in which light is mostly not condensed. In this manner, the anisotropic light condenser 41 is a periodic structure, and has a property of selectively condensing light in a specific direction, or in other words, anisotropic light-condensation.

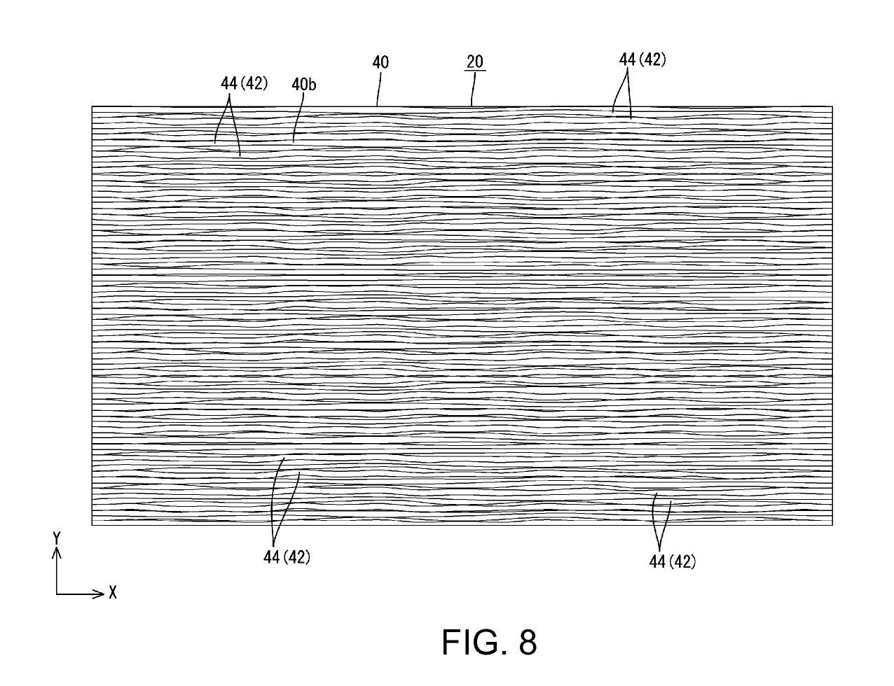

As shown in FIGS. 6 and 8, the anisotropic light scatterer 42 is provided integrally with the light-emitting surface 40b, the light-emitting surface 40b being the front surface of the base member 40 where light that has been condensed by the anisotropic light condenser 41 and light to which such effects have not been applied passes through the base member 40. The light-emitting surface 40b opposes the liquid crystal panel 11 disposed to the front thereof (see FIG. 4). The anisotropic light scatterer 42 is made of an almost transparent ultraviolet curable resin, which is a type of photocurable resin. The ultraviolet curable resin has an almost transparent resin such as an acrylic resin as the main material, for example, the resin having the property of being cured (having an increase in viscosity) by being irradiated with ultraviolet light (UV light), the resin having an index of refraction higher than air and being substantially the same as that of the light guide plate 19. The ultraviolet curable resin of the anisotropic light scatterer 42 is the same as the ultraviolet curable resin of the anisotropic light condenser 41. With regard to manufacturing, a not yet cured ultraviolet curable resin is filled into a mold and the base member 40 is placed on the opening of that mold, thereby placing the ultraviolet curable resin, which has not yet been cured, in contact with the light-emitting surface 40b, and irradiating the ultraviolet curable resin with ultraviolet light through the substrate 40 in this state to cure the ultraviolet curable resin and form the anisotropic light scatterer 42.

As shown in FIGS. 6 and 8, the anisotropic light scatterer 42 is constituted of a plurality of ridges 44 that protrude towards the front (towards the liquid crystal panel 11) in the Z axis direction from the light-emitting surface 40b of the base member 40. The ridges 44 have a substantially mountain shape in a cross-sectional view taken along the Y axis direction and extend in the X axis direction in a meandering fashion, and a plurality of the ridges 44 are arranged on the light-emitting surface 40b in parallel with each other in the Y axis direction. Each ridge 44 has a substantially isosceles triangular shape in a cross-sectional view, the ridge 44 having a pair of inclined faces 44a leading to a vertex. The vertex of the ridge 44 is at an acute angle, each inclined face 44a thereof is at an incline with respect to the Y axis direction and the Z axis direction, and the angle of incline (vertex) changes depending on the position in the X axis direction. In other words, the inclined faces 44a of the ridges 44 are overall inclined towards the front with respect to the Y axis direction, but have a meandering shape to form a curved surface of an indefinite shape. More specifically, the ridges 44 have a meandering shape, and thus, besides the angle of incline of the inclined faces 44a, the width of the bottom side, the height (position of the vertex in the Z axis direction), and the position of the vertex in the Y axis direction vary in a random fashion depending on the position in the X axis direction (see FIGS. 9 and 10). Furthermore, among the plurality of ridges 44 arranged in the Y axis direction, adjacent ridges 44 are often not parallel to each other, and meander in a random fashion. FIG. 8 schematically shows an example of an arrangement of ridges 44 on the optical sheet 20.

When light from the base member 40 enters the ridges 44 having such a configuration, then as shown in FIGS. 9 and 10, the light passing through the ridges 44 is refracted at the boundary between the inclined face 44a and the air layer, which causes the light to be emitted at an angle based on the shape of the curved surface (meandering shape) of the inclined face 44a. At this time, the light emitted from the inclined face 44a is largely emitted towards the Y axis direction, but the direction of emission subtly varies depending on the position in the X axis direction. As a result, the light emitted in the Y axis direction from the ridges 44 is appropriately scattered. Meanwhile, the amount of light emitted in the X axis direction from the ridges 44 is less than the amount of light emitted in the Y axis direction. Thus, in the anisotropic light scatterer 42 of the present embodiment, the Y axis direction, which is the direction in which the plurality of ridges 44 are aligned, is a dominant light scattering direction in which light is greatly scattered, whereas the X axis direction, which is the direction in which the ridges 44 extend, is a non-dominant light scattering direction in which light scattered to a lesser degree. In the anisotropic light scatterer 42, the dominant light scattering direction matches the light-condensing direction of the anisotropic light condenser 41, and the non-dominant light scattering direction matches the non-light-condensing direction of the anisotropic light condenser 41. As a result, the light condensed by the anisotropic light condenser 41 can be scattered by the anisotropic light scatterer 42, whereas scattering by the anisotropic light scatterer 42 of the light that has not been condensed by the anisotropic light condenser 41 can be mitigated. Thus, it is possible to appropriately alleviate directivity of light supplied from the optical sheet 20 to the liquid crystal panel 11, such directivity resulting from the condensing of light by the anisotropic light condenser 41. As described above, the anisotropic light scatterer 42 is a non-periodic structure, and has the property of scattering more light selectively in a specific direction, or in other words, anisotropic light scattering. FIGS. 9 and 10 are cross-sectional views of the optical sheet 20 and the light guide plate 19 taken in the X axis direction, but the cross-sections are taken respectively in different positions in the Y axis direction.

The inclined faces 44a of the ridges 44 constituting the anisotropic light scatterer 42 have random variations in angle of incline and direction depending on the position in the X axis direction, and thus, light emitted from the inclined faces 44a is randomly scattered, which allows the directivity of the emitted light to be suitably alleviated. Furthermore, the plurality of ridges 44 constituting the anisotropic light scatterer 42 randomly meander, and thus, light emitted by the ridges 44 is randomly scattered based on the meandering shape, which even more suitably alleviates the directivity of the emitted light. As described above, not only do the individual ridges 44 constituting the anisotropic light scatterer 42 have random variations in the angle of incline of the inclined face 44a, the width of the bottom side, and the height depending on the position in the X axis direction, adjacent ridges 44 have meandering shapes that randomly differ from each other. Thus, interference between the arrangement of unit pixels PX (see FIG. 5) of the liquid crystal panel 11 to which light is supplied and the arrangement of the ridges 44 is unlikely to occur, which allows an interference pattern known as a moiré pattern to be mitigated in the liquid crystal panel 11.

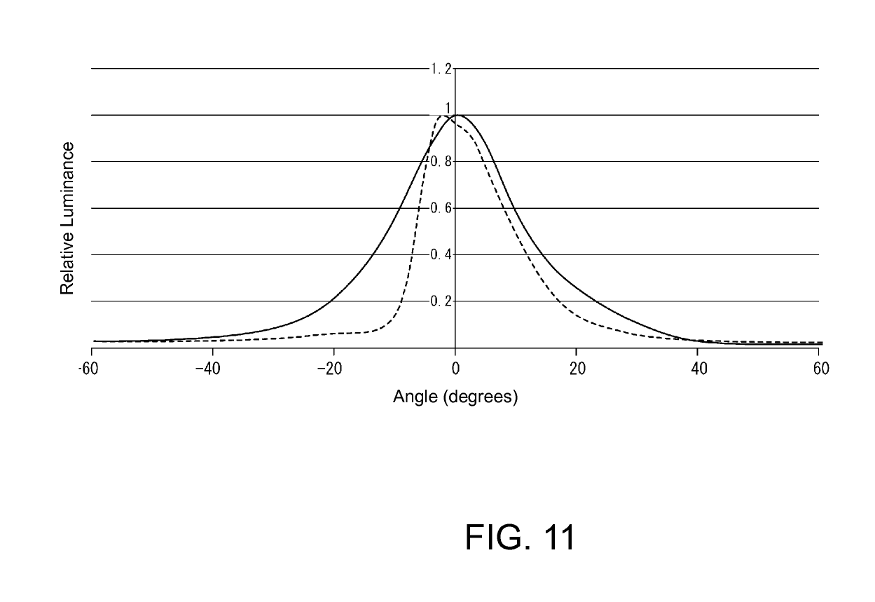

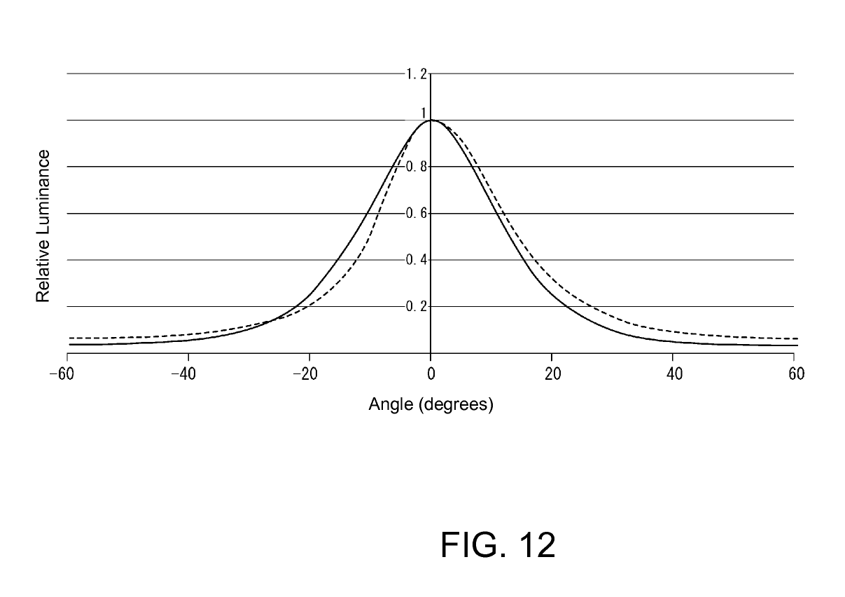

A comparison experiment between the optical sheet 20 of the present embodiment and a prism sheet that does not include an anisotropic light scatterer 42 as in the present embodiment (not shown) will be described. In the comparison experiment, a backlight device 12 using the optical sheet 20 of the present embodiment is a working example, and a backlight device having a prism sheet provided with an anisotropic light condenser similar to the present embodiment on the light-receiving surface of the base member but having a light-emitting surface is a comparison example. In the comparison experiment, the luminance of light emitted from the respective backlight devices is measured, and the measurement results are shown in FIGS. 11 and 12. FIGS. 11 and 12 indicate the relative luminance of light emitted from the backlight device in the vertical axis, and indicate the angle (the unit is “degrees”) of the light with respect to the frontal direction in the horizontal axis. The relative luminance of the vertical axis in FIGS. 11 and 12 is a relative value with the front luminance as a reference (1.0). In the graphs of FIGS. 11 and 12, the solid line curve indicates the luminance distribution of light emitted in the X axis direction, whereas the broken line curve indicates the luminance distribution of light emitted in the Y axis direction. The only differences between the structures of the backlight device 12 of the working example and the backlight device of the comparison example are the optical sheet 20 and the prism sheet.

The results of the comparison experiment will be described below. First, as shown in FIG. 11, in the comparison example, the prism sheet condenses almost none of the light emitted in the X axis direction, which means that the luminance distribution is at a gentle curve, whereas the prism sheet condenses light emitted in the Y axis direction, which causes a steep luminance distribution curve. In other words, the light emitted in the Y axis direction from the prism sheet of the comparison example includes too much light traveling towards the front, and there is too much difference between this amount and the amount of light traveling diagonally. Specifically, in the prism sheet of the comparison example, the full angle at half maximum (angle range in which the relative luminance is 0.5 or greater) of the light emitted in the X axis direction is wide at approximately 24°, but the full angle at half maximum of the light emitted in the Y axis direction is narrow at approximately 17°. Thus, in the comparison example, there is a difference in angle range, in which a luminance of a certain level can be ensured is great, between the light emitted in the X axis direction and the light emitted in the Y axis direction, and the viewing angle characteristics in the Y axis direction are worse.

By contrast, as shown in FIG. 12, in the optical sheet 20 of the modification example, almost none of the light emitted in the X axis direction is condensed by the anisotropic light condenser 41, and almost none of this light is scattered by the anisotropic light scatterer 42 (light scattering is mitigated), and thus, a gentle luminance distribution curve can be attained. While the light emitted in the Y axis direction in the working example is condensed by the anisotropic light condenser 41, the light is also greatly scattered by the anisotropic light scatterer 42 (light scattering is encouraged), thereby allowing for a gentle luminance distribution curve. Specifically, the optical sheet 20 of the working example has a full angle at half maximum (angle range where the relative luminance is 0.5 or greater) of approximately 26° for light emitted in the X axis direction, and a full angle at half maximum of approximately 26° for light emitted in the Y axis direction, making the two values almost equal. Thus, in the working example, the light emitted in the X axis direction and the light emitted in the Y axis direction are almost equal at an angle range where a certain luminance can be ensured, and thus, wide viewing angle characteristics can be attained at any angle.

As described above, the optical sheet 20 (optical member) of the present embodiment includes: a sheet-shaped base material 40 that is light-transmissive; an anisotropic light condenser 41 that is formed on the light-receiving surface 40a of the base material 40 where light is received, the anisotropic light condenser 41 having light condensing anisotropy such that incident light is condensed in a light condensing direction along the light-receiving surface 40a whereas light is not condensed in a non-light condensing direction along the light-receiving surface 40a, the non-light condensing direction being perpendicular to the light condensing direction; and an anisotropic light scatterer 42 that is formed on the light-emitting surface 40b from which light is emitted, the light-emitting surface 40b being on a side of the base material 40 opposite to the light-receiving surface 40a of the base member 40, the anisotropic light scatterer 42 scattering and emitting light from the anisotropic light condenser 41, and having light scattering anisotropy where light is greatly scattered in the light condensing direction but scattered to a lesser degree in the non-light condensing direction.

In this manner, light received by the light-receiving surface 40a of the sheet-shaped base member 40 is condensed in the light condensing direction by the anisotropic light condenser 41 having light condensing anisotropy, but not condensed in the non-light condensing direction. Light that has passed through the base member 40 from the anisotropic light condenser 41 and reached the anisotropic light scatterer 42, which is formed on the light-emitting surface 40b is scattered by the anisotropic light scatterer 42 and emitted. The anisotropic light scatterer 42 has light scattering anisotropy such that the amount of scattering is relatively high in the light condensing direction but relatively low in the non-light condensing direction, and thus, scattering of light condensed by the anisotropic light condenser 41 is encouraged, and scattering of light that has not been condensed by the anisotropic light condenser 41 is mitigated. By condensing light in the light condensing direction using the anisotropic light condenser 41 in this manner, it is possible to increase the front luminance of light emitted by the optical sheet 20, and to alleviate directivity that can occur in light using the light scattering anisotropy of the anisotropic light scatterer 42. In this manner, according to the present embodiment, it is possible to mitigate directionality of emitted light while maintaining the front luminance thereof at a high level.

The anisotropic light scatterer 42 has a plurality of ridges 44 that protrude from the light-emitting surface 40b, the ridges 44 having a substantially mountain shape in a cross-sectional view taken in the light condensing direction and extending in the non-light condensing direction, the ridges 44 being arranged in parallel in the light condensing direction. In this manner, the ridges 44 of the anisotropic light scatterer 42 have a substantially mountain shape in a cross-sectional view taken in the light condensing direction, and thus, light emitted from the inclined face 44a at an angle based on the vertex angle generally travels in the light condensing direction. As a result, the amount of light emitted from the ridges 44 in the light condensing direction is greater than the amount of light emitted in the non-light condensing direction. Furthermore, the ridges 44 meander while extending in the non-light condensing direction, and the inclined faces 44a have a meandering shape, and thus, the direction of light outputted from the inclined face 44a varies depending on the position in the non-light condensing direction. As a result, light generally emitted in the light condensing direction from the ridges 44 is appropriately scattered. Thus, the anisotropic light scatterer 42 has light scattering anisotropy such that the amount of light scattered in the light condensing direction is relatively large and the amount of light scattered in the non-light condensing direction is relatively small.

The plurality of ridges 44 aligned in the light condensing direction meander randomly in the non-light condensing direction. In this manner, light emitted from the respective inclined faces 44a of the ridges 44 is scattered randomly based on the meandering shape of the ridges 44. Thus, even when the liquid crystal panel 11 (display panel), which has the unit pixels PX (pixels) arranged periodically, for example, is provided to oppose the optical sheet 20 in the light emission direction, interference between the arrangement of the unit pixels PX and the arrangement of the ridges 44 of the anisotropic light scatterer 42 is unlikely to occur, and thus, moiré patterns (interference patterns) are suppressed in the liquid crystal panel 11.

The ridges 44 are formed such that at least one of the width and height varies at random based on the position in the non-light condensing direction. In this manner, in the ridges 44, the angle of the vertex and the direction of the inclined face 44a vary depending on the position in the non-light condensing direction, and thus, the light outputted from the inclined face 44a is randomly scattered. Thus, even when the liquid crystal panel 11, which has the unit pixels PX arranged periodically, for example, is provided to oppose the optical sheet 20 in the light emission direction, interference between the arrangement of the unit pixels PX and the arrangement of the ridges 44 of the anisotropic light scatterer 42 is unlikely to occur, and thus, moiré patterns (interference patterns) are suppressed in the liquid crystal panel 11.

The base member 40 is formed by biaxially stretching a thermoplastic resin to form a sheet, whereas the anisotropic light condenser 41 and the anisotropic light scatterer 42 are formed by forming a photocurable resin on each surface of the base member 40 and curing the photocurable resin by light. In this manner, the photocurable resin, which formed on the respective surfaces of the base member 40 having a sheet shape by biaxially stretching a thermoplastic resin, is cured by being irradiated with light, thereby forming the anisotropic light condenser 41 and the anisotropic light scatterer 42. Compared to a case in which the base member, the anisotropic light condenser, and the anisotropic light scatterer were made of the same thermoplastic resin, various effects such as shortened takt time for manufacturing can be attained.

Also, the anisotropic light condenser 41 and the anisotropic light scatterer 42 are made of an ultraviolet curable resin. In this manner, compared to a case in which a visible light photocurable resin were used, costs associated with equipment and the like can be kept low because measures necessary to prevent unwanted curing of the ultraviolet curable resin are relatively simple. Also, the ultraviolet curable adhesive material is more quickly cured, and thus, the takt time can be even further reduced.

Also, the anisotropic light condenser 41 has a plurality of prisms 43 aligned in the light condensing direction, the prisms 43 protruding from the light-receiving surface 40a and having a substantially mountain shape in a cross-section taken in the light-condensing direction and extending in a straight line in the non-light condensing direction. In this manner, the prisms 43 of the anisotropic light condenser 41 are formed in a substantially mountain shape in a cross-sectional view along the light condensing direction, and thus, when light that incident on the prism 43 hits the inclined faces 43a of the prisms 43, the light travels towards the front at an angle based on the vertex angle. As a result, the light is condensed as it travels in the light condensing direction from the prisms 43 towards the base member 40. On the other hand, the prisms 43 extend in a straight line along the non-light condensing direction, and thus, light traveling from the prisms 43 towards the base member 40 in the non-light condensing direction is not condensed.

Next, the backlight device 12 (illumination device) of the present embodiment includes an optical sheet 20 described above, LEDs 17 (light source), and a light guide plate 19 having a light-receiving face 19b that receives light from the LEDs 17 and a light-emitting surface 19a that faces the light-receiving surface 40a of the optical sheet 20 and from which light exits. According to the backlight device 12 having this configuration, light from the LEDs 17 enters the light guide plate 19 through the light-receiving face 19b, is propagated inside the light guide plate 19, and then emitted from the light-emitting surface 19a to enter the light-receiving surface 40a of the optical sheet 20. Because the light emitted from the optical sheet 20 has a high front luminance while the directivity thereof is alleviated, the light emitted by the backlight device 12 has a high front luminance with the directivity thereof being alleviated, and thus, uneven luminance is made unlikely.

Next, the liquid crystal display device 10 (display device) of the present embodiment includes the backlight device 12 and the liquid crystal panel 11, which performs display using light from the backlight device 12. According to the liquid crystal display device 10 configured in this manner, excellent display quality can be attained because the light emitted from the backlight device 12 has a high front luminance with uneven luminance unlikely to occur.

The display panel is a liquid crystal panel 11 having liquid crystal sealed between a pair of substrates 11a and 11b. Such a liquid crystal display device 10 can be applied to various applications such as displays for smartphones and tablet PCs, for example.

### Embodiment 2

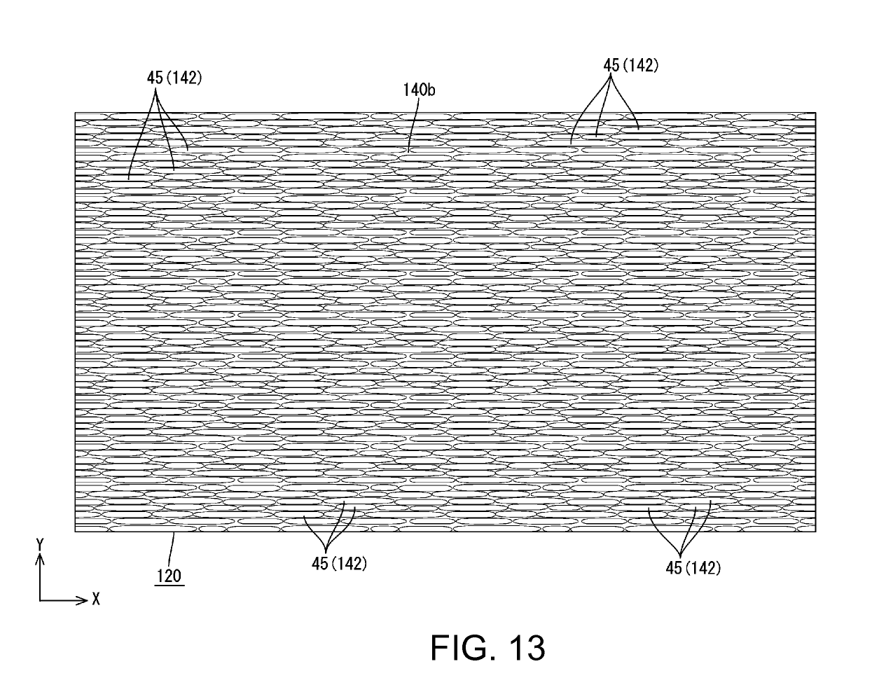

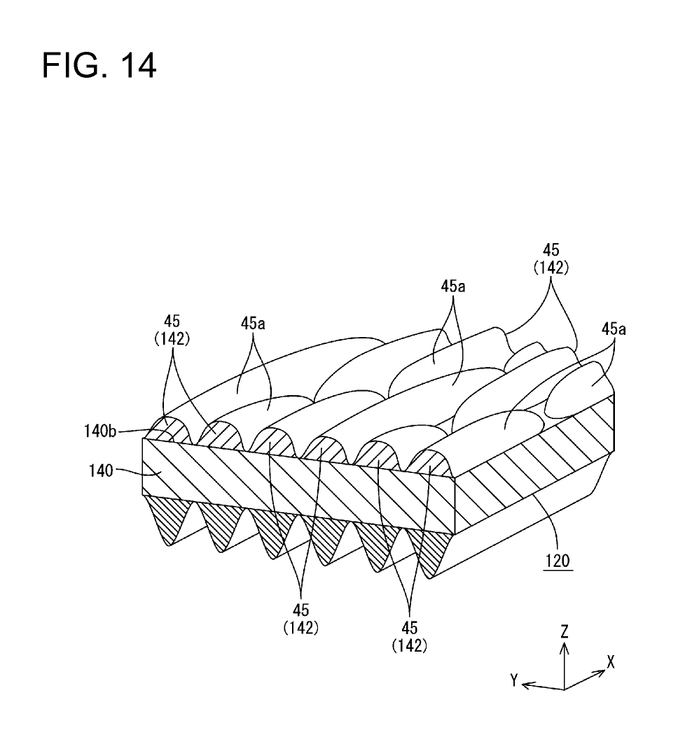

Embodiment 2 of the present invention will be described with reference to FIGS. 13 to 15. In Embodiment 2, the configuration of the anisotropic light scatterer 142 is modified. Descriptions of structures, operations, and effects similar to those of Embodiment 1 will be omitted.

As shown in FIGS. 13 to 15, the anisotropic light scatterer 142 of the present embodiment includes a plurality of microlenses 45 that protrude towards the front in the Z axis direction from a light-emitting surface 140b of a base member 140 of an optical sheet 120. The microlens 45 has a substantially elliptical shape in a plan view in which the long axis direction thereof is the X axis direction and the short axis direction is the Y axis direction, and is a substantially hemispherical convex lens. The microlens 45 has a horizontally long spherical surface 45a as the outer surface thereof, and light in the microlens 45 can be refracted at the boundary between the spherical surface 45a and the air layer and then outputted. The microlens 45 has a substantially semicircular shape in a cross-sectional view along the Y axis direction but has a substantially semi-elliptical shape in a cross-sectional view along the X axis direction. A plurality of the microlenses 45 having this shape are arranged on the light-emitting surface 140b in the X axis direction and the Y axis direction. Each of the microlenses 45 arranged in the X axis direction and the Y axis direction is formed such that the size in a plan view (long axis dimension and short axis dimension) and the height are randomly set. The microlens 45 is made of an ultraviolet curable resin similar to the ridges 44 of Embodiment 1. FIG. 13 schematically shows an arrangement of microlenses 45 on the optical sheet 120.

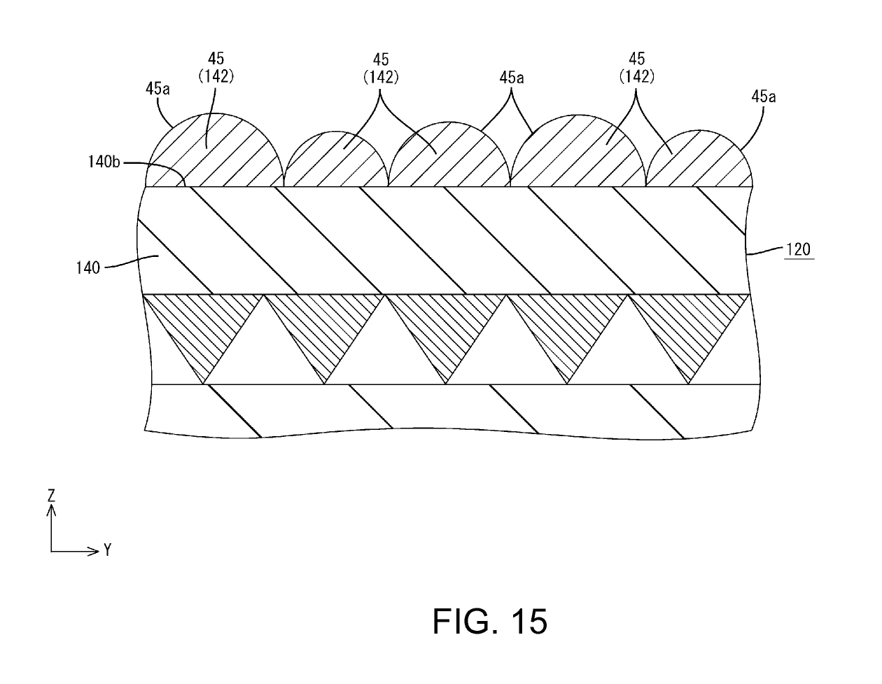

When light enters the microlenses 45 of this configuration from the base member 140, then as shown in FIG. 15, the light passing through the microlens 45 is refracted at the boundary between the spherical surface 45a and the air layer, and thus, light is emitted at an angle based on the shape of the spherical surface 45a. At this time, a greater amount of light is emitted from the spherical surface 45a in the short axis direction (Y axis direction) of the microlens 45 than in the long axis direction (X axis direction). Thus, the anisotropic light scatterer 142 of the present embodiment has the dominant light scattering direction in which light is greatly scattered as the Y axis direction, which is the short axis direction of the microlens 45, and a non-dominant light scattering direction in which light is scattered to a lesser degree as the X axis direction, which is the long axis direction of the microlens 45. Also, the plurality of microlenses 45 are arranged in the X axis direction and the Y axis direction with the plan view size and height being random, thereby randomly scattering light emitted from the spherical surface 45a of each microlens 45 and more suitably alleviating directivity in the emitted light. As a result, interference is unlikely between the arrangement of unit pixels of the liquid crystal panel to which light emitted from the anisotropic light scatterer 142 is emitted (see FIG. 5) and the arrangement of the microlenses 45, and thus, an interference pattern known as a moiré pattern is mitigated in the liquid crystal panel.

As described above, according to the present embodiment, the anisotropic light scatterer 142 includes a plurality of microlenses 45 arranged along the non-light condensing direction and the light condensing direction, the microlenses 45 protruding from the light-emitting surface 140b of the base member 140 and having a substantially elliptical shape in a plan view, with the long axis direction thereof being the non-light condensing direction and the short axis direction thereof being the light condensing direction. In this manner, the microlenses 45 of the anisotropic light scatterer 142 are substantially elliptical in a plan view with the non-light condensing direction being the long axis direction and the light condensing direction being the short axis direction, and thus, the amount of light emitted in the light condensing direction is greater than the amount of light emitted in the non-light condensing direction. By the anisotropic light scatterer 142 being configured such that the plurality of microlenses 45 are arranged in the non-light condensing direction and the light condensing direction, the anisotropy of light emitted from the microlenses 45 is maintained while appropriately scattering the light.

Also, the plurality of microlenses 45 are formed such that at least one of the plan view size and the height is randomized. In this manner, the microlenses 45 have at least one of the plan view size and the height randomized, and therefore, the light can be scattered randomly by the microlenses 45. As a result, even if the liquid crystal panel having unit pixels arranged periodically in parallel with each other is disposed opposite to the light emission side of the optical sheet 120, the arrangement of the unit pixels is unlikely to interfere with the arrangement of the microlenses 45 constituting the anisotropic light scatterer 142, and thus, a moiré pattern (interference pattern) is mitigated in the liquid crystal panel.

### Embodiment 3

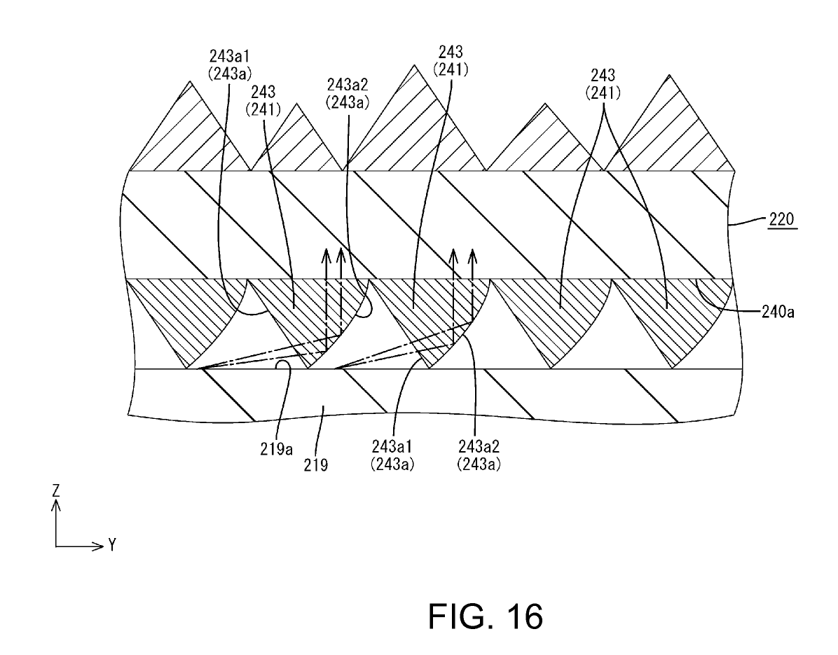

Embodiment 3 of the present invention will be described with reference to FIG. 16. In Embodiment 3, the configuration of the anisotropic light condenser 241 is modified. Descriptions of structures, operations, and effects similar to those of Embodiment 1 will be omitted.

As shown in FIG. 16, prisms 243 constituting the anisotropic light condenser 241 of the present embodiment have a pair of inclined faces 243a of which one inclined face 243a1 is a substantially straight line in a cross-sectional view whereas the other inclined face 243a2 is an arced curve in a cross-sectional view. In other words, the prisms 243 are asymmetrical in a cross-sectional view along the Y axis direction. When distinguishing the pair of inclined faces 243a from each other, one of the inclined faces has a “1” appended to the reference character thereof while the other inclined face has a “2” appended to the reference character thereof, and when not distinguishing the two, no character is appended. One inclined face 243a1 is to the left of the vertex of the prism 243 in FIG. 16, or in other words, closer to the LEDs (light-receiving face of the light guide plate 219), whereas the other inclined face 243a2 is to the right of the vertex of the prism 243 in FIG. 16, or in other words, farther from the LEDs (light-receiving face of the light guide plate 219). The light emitted from the light-emitting surface 219a of the light guide plate 219 travels in a direction inclined with respect to the light-emitting surface 219a, and includes a front direction component and a component in a direction from the LEDs to the light-receiving face of the light guide plate 219. By contrast, the other inclined face 243a2 of the prism 243 is an arced curve in a cross-sectional view, and thus, it is possible to efficiently redirect light entering the prism 243 along the above-mentioned inclined direction of travel from the light-emitting surface 219a such that the light travels towards the front. As a result, it is possible to further increase the condensing effect of the anisotropic light condenser 241, and it is possible to further improve front luminance.

As described above, according to the present embodiment, the anisotropic light condenser 241 includes a plurality of prisms 243 arranged in row on the light-receiving surface 240a, the prisms 243 having a substantially mountain shape in a cross-sectional view taken along the direction in which the LEDs and the light guide plate 219 are aligned and having a pair of inclined faces 243a, the prisms 243 extending in a straight line in the direction perpendicular to this direction. Of the pair of inclined faces 243a of the prism 243, the cross-sectional shape of the inclined face 243a2, which is on the side opposite to that of the LEDs, is either a curve or a polygonal line. In this manner, the direction in which the light travels from the light-emitting surface 219a of the light guide plate 219 to the light-receiving surface 240a of the optical sheet 220 is generally inclined with respect to the light-emitting surface 219a, and includes a component normal to the light-emitting surface 219a and a component traveling in a direction towards the light-receiving face of the light guide plate 219 from the LEDs. As a countermeasure, the anisotropic light condenser 241 forms substantially mountain shapes in a cross-sectional view taken along the direction in which the LEDs and the light guide plate 219 are aligned with respect to each other, each of the mountain shapes having a pair of inclined faces 243a. Of the pair of inclined faces 243a, the inclined face 243a2 that is opposite to the inclined face towards the LEDs is a curve or polygonal line in a cross-sectional view, and thus, light entering the prism 243 along the direction of travel of light mentioned above can be efficiently redirected towards the front. As a result, it is possible to effectively improve front luminance.

### Embodiment 4

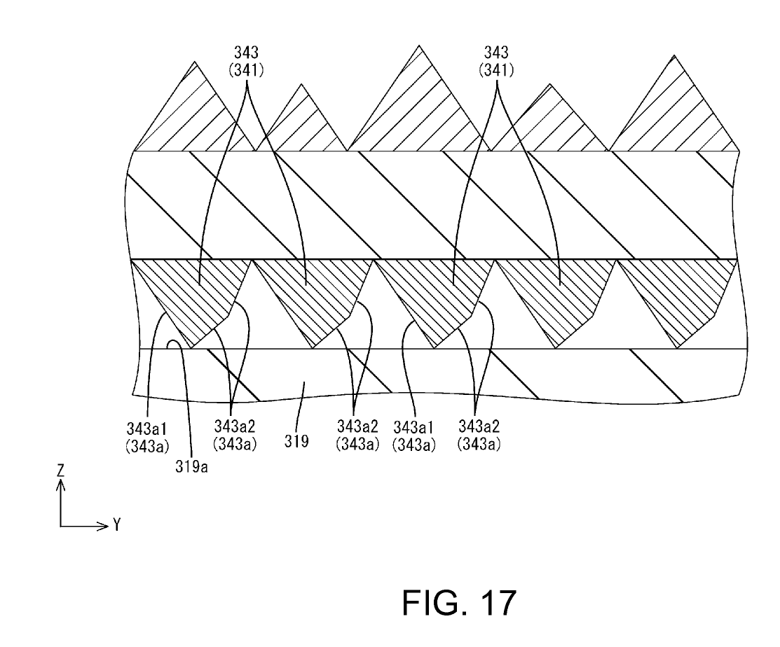

Embodiment 4 of the present invention will be described with reference to FIG. 17. In Embodiment 4, the configuration of the anisotropic light condenser 341 is further modified from that of Embodiment 3. Descriptions of structures, operations, and effects similar to those of Embodiment 3 will be omitted.

As shown in FIG. 17, a prism 343 of an anisotropic light condenser 341 according to the present embodiment has a pair of inclined faces 343a, of which one inclined face 343a1 (closer to the LEDs) is a substantially straight line in a cross-sectional view, and the other inclined face 343a2 (farther from the LEDs) is a polygonal line formed by connecting two inclined lines in a cross-sectional view. Even with prisms 343 configured in this manner, the other inclined face 343a2 can efficiently redirect light, entering the prism 343 along a direction diagonal to the front direction from the light-emitting surface 319a, towards the front.

### Embodiment 5

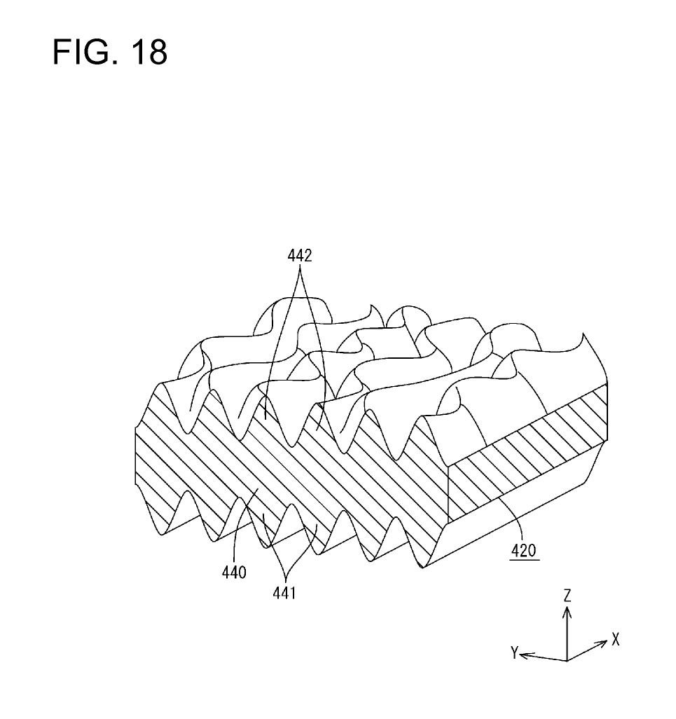

Embodiment 5 of the present invention will be described with reference to FIG. 18. In Embodiment 5, the base member 440, the anisotropic light condenser 441 and the anisotropic light scatterer 442 are formed integrally of the same material. Descriptions of structures, operations, and effects similar to those of Embodiment 1 will be omitted.

As shown in FIG. 18, an optical sheet 420 of the present embodiment is made of a single thermoplastic resin such as PET. The optical sheet 420 can be manufactured by forming all at once the base member 440, the anisotropic light condenser 441, and the anisotropic light scatterer 442 by injection-forming, for example. Besides this, it is possible to use thermal imprinting for example; specifically, it is possible to heat a sheet shaped base member 440 having smooth surfaces and press the sheet onto a transfer mold to transfer the surface shape of the transfer mold to the surface of the base member 440, thereby forming the anisotropic light condenser 441 and the anisotropic light scatterer 442. It is also possible to manufacture the optical sheet 420 by extrusion. By integrally forming the base member 440, the anisotropic light condenser 441 and the anisotropic light scatterer 442 of the same material in this manner, there is no step of biaxially stretching the base member 40 as in Embodiment 1, and thus, when mass producing the optical sheets 420, variations in polarizing state that can occur when transmitting light through the base member 440 are made unlikely. As a result, the optical characteristics of light emitted from the optical sheet 420 are stable.

As described above, according to the present embodiment, the base member 440, the anisotropic light condenser 441, and the anisotropic light scatterer 442 are integrally formed of a thermoplastic resin. In this manner, when mass producing the optical sheets 420, variation in polarizing state that can occur when light is transmitted through the base member 440 is unlikely compared to a case in which the base member is formed by biaxially stretching a thermoplastic resin and forming the anisotropic light condenser and the anisotropic light scatterer, made of a different material from the base member, on each surface of the base member. As a result, the optical characteristics of light emitted from the optical sheet 420 can be made stable.

### Other Embodiments

The present invention is not limited to the embodiments shown in the drawings and described above, and the following embodiments are also included in the technical scope of the present invention, for example.

(1) In Embodiment 1, a plurality of ridges aligned along the light condensing direction randomly meander along the non-light condensing direction, but it is possible to have the plurality of ridges aligned along the light condensing direction be parallel to each other while meandering in a regular manner.

(2) In Embodiment 1, the ridges extending in the non-light condensing direction and meandering have randomly varying widths, heights, and the like depending on the position in the non-light condensing direction, but the ridges can meander while maintaining a constant width, height, and the like.

(3) In Embodiment 2, a plurality of microlenses arranged in the light condensing direction and the non-light condensing direction are formed such that the plan view size, height, and the like thereof vary randomly, but it is also possible for the microlenses to have a constant plan view size, height, and the like.

(4) In Embodiment 3, the other inclined face of the prism is an arced curve in a cross-sectional view, but it is also possible to form the other inclined face of the prism as a non-arced curve in a cross-sectional view (such as a wave).

(5) In Embodiment 4, the other inclined face of the prism is a polygonal line in a cross-sectional view formed by connecting two inclined lines, but the other inclined face can also be a polygonal line in a cross-sectional view formed by connecting three or more inclined lines.

(6) In the embodiments above, an ultraviolet curable resin, which is a type of photocurable resin cured by ultraviolet light, is used as the material for the anisotropic light condenser and the anisotropic light scatterer, but it is possible to use another type of photocurable resin such as a visible light photocurable resin, which is cured by visible light. Besides these, a type of photocurable resin cured by both ultraviolet rays and visible light can be used.

(7) In the embodiments above, the anisotropic light condenser and the anisotropic light scatterer are made of the same material, but it is possible to form the anisotropic light condenser and the anisotropic light scatterer of different materials.

(8) In the embodiments above, the index of refraction of the material forming the anisotropic light condenser and the anisotropic light scatterer are made equal to that of the light guide plate, but the index of refraction of the anisotropic light condenser and the anisotropic light scatterer can be made higher or lower than that of the light guide plate.

(9) In Embodiments 1 to 4, the base member is made by biaxial stretching, but it is possible to form the base member by another method such as extrusion or injection-forming.

(10) In the embodiments above, the light condensing direction of the anisotropic light condenser matches the Y axis direction and the non-light condensing direction thereof matches the X axis direction, but it is also possible to have the light condensing direction of the anisotropic light condenser match the X axis direction with the non-light condensing direction thereof matching the Y axis direction. In such a case, the dominant light scattering direction of the anisotropic light scatterer needs to match the X axis direction with the non-dominant light scattering direction matching the Y axis direction.

(11) In the embodiments above, the anisotropic light scatterer is constituted of a plurality of ridges or a plurality of microlenses with light being scattered in random directions, but it is also possible to form the anisotropic light scatterer by arranging a plurality of lenticular lenses along the light condensing direction in a regular fashion, the lenticular lenses having a semicircular shape in a cross-sectional view taken along the light condensing direction and extending in the non-light condensing direction, for example.

(12) In the embodiments above, only one optical sheet was used, but it is possible to add other types of optical sheets (such as a diffusion sheet, a prism sheet, and a reflective type polarizing sheet).

(13) In the embodiments above, one LED substrate is provided along the light-receiving face of the light guide plate, but the present invention also includes an arrangement in which two or more LED substrates are disposed along the light-receiving face of the light guide plate.

(14) In the embodiments above, an LED substrate is provided along one long side face of the light guide plate, but a configuration in which the LED substrate is provided along one short side face of the light guide plate is also included in the present invention.

(15) Besides the configuration of (14), a configuration in which LED substrates are provided to oppose the pair of long edge faces of the light guide plate or a configuration in which LED substrate are provided to oppose the pair of short edge faces of the light guide plate are also included in the present invention.

(16) Besides (14) and (15), a configuration in which LED substrates are provided to oppose three appropriate edge faces of the light guide plate, or a configuration in which LED substrates are provided to oppose all four edge faces of the light guide plate are also included in the present invention.

(17) In the embodiments above, the touch panel pattern on the touch panel was of the projected capacitive type, but besides this, the present invention can be applied to a surface capacitive type, a resistive film type, or an electromagnetic induction type touch panel pattern, or the like.

(18) Instead of the touch panel in the embodiments above, a parallax barrier panel (switching liquid crystal panel) may be formed, the parallax barrier panel having a parallax barrier pattern for allowing a viewer to see a three dimensional image (3D image) by separating by parallax images displayed in the display surface of the liquid crystal panel. Also, it is possible to have both a parallax barrier panel and a touch panel.

(19) It is also possible to form a touch panel pattern on the parallax barrier panel in (18) to have the parallax barrier panel double as a touch panel.

(20) In the embodiments above, the display size of the liquid crystal panel used in the liquid crystal display device is approximately 20 inches, but the specific display size of the liquid crystal panel can be appropriately modified to a size other than 20 inches. In particular, if the display size is a few inches, it is suitable to be used in electronic devices such as smartphones.

(21) In the respective embodiments above, the colored portions of the color filters provided in the liquid crystal panel included the three colors of R, G, and B, but it is possible to have the colored portions include four or more colors.

(22) In the respective embodiments above, LEDs were used as the light source, but other types of light sources may also be used.

(23) In the embodiments above, the frame is made of metal, but can also be made of a synthetic resin.

(24) In the respective embodiments above, the cover panel is made of tempered glass that is tempered by being chemically strengthened, but a tempered glass that is strengthened by air cooling (physical strengthening) can naturally be used.

(25) In the respective embodiments above, a tempered glass being used as the cover panel was shown as an example, but an ordinary glass material (non-tempered glass) or a synthetic resin can also be used.

(26) In the respective embodiments above, a cover panel is used on the liquid crystal display device, but the cover panel can be omitted. Similarly, the touch panel can also be omitted.

(27) In the respective embodiments, a case was described in which an edge-lit backlight device is used in the liquid crystal display device, but a configuration having a direct-lit backlight device is also included in the present invention.

(28) In the respective embodiments above, the display surface is a horizontally long liquid crystal display device, but a liquid crystal display device in which the display surface is vertically long is also included in the present invention. Also, a liquid crystal display device in which the display surface is square is also included in the present invention.

(29) In the respective embodiments above, TFTs are used as the switching element in the liquid crystal display device, but the present invention can be applied to a liquid crystal display device that uses a switching element other than a TFT (a thin film diode (TFD), for example), and, besides a color liquid crystal display device, the present invention can also be applied to a black and white liquid crystal display device.

### DESCRIPTION OF REFERENCE CHARACTERS

10 liquid crystal display device (display device)
11 liquid crystal panel (display panel)
11a, 11b substrate
12 backlight device (illumination device)
17 LED (light source)
19, 219, 319 light guide plate
19a, 219a, 319a light-emitting surface
19b light-receiving face
20, 120, 220, 420 optical sheet (optical member)
40, 140, 440 base member
40a, 240a light-receiving surface
40b, 140b light-emitting surface
41, 241, 341, 441 anisotropic light condenser
42, 142, 442 anisotropic light scatterer
43, 243, 343 prism
43a, 243a, 343a inclined face
44 ridge
44a inclined face
45 microlens
243a1, 343a1 inclined face
243a2, 343a2 inclined face
PX unit pixel (pixel)

1. An optical member, comprising:
a sheet-shaped base member that is light-transmissive;
an anisotropic light condenser formed on a light-receiving surface of the base member that receives light, the anisotropic light condenser having light condensing anisotropy such that the received light is condensed in a light condensing direction along the light-receiving surface but the received light is not condensed in a non-light condensing direction along the light-receiving surface and perpendicular to the light condensing direction; and
an anisotropic light scatterer formed on a light-emitting surface of the base material from which light is emitted, the light-emitting surface being opposite to the light-receiving surface, the anisotropic light scatterer scattering and emitting light from the anisotropic light condenser, and having light scattering anisotropy such that the light is scattered to a greater degree in the light condensing direction but the light is scattered to a lesser degree in the non-light condensing direction.

2. The optical member according to claim 1, wherein the anisotropic light scatterer includes a plurality of ridges aligned in the light condensing direction, the ridges protruding from the light-emitting surface and each having a substantially mountain shape in a cross-sectional view along the light condensing direction, the ridges extending in a meandering fashion in the non-light condensing direction.

3. The optical member according to claim 2, wherein the plurality of ridges aligned in the light condensing direction are formed so as to meander randomly along the non-light condensing direction.

4. The optical member according to claim 2, wherein the ridges are formed such that at least one of a width and a height thereof varies randomly depending on a position in the non-light condensing direction.

5. The optical member according to claim 1, wherein the base member is formed in a sheet shape by biaxially stretching a thermoplastic resin material whereas the anisotropic light condenser and the anisotropic light scatterer are formed by radiating light to cure photocurable resin materials disposed to be in contact with respective surfaces of the base member.

6. The optical member according to claim 5, wherein the anisotropic light condenser and the anisotropic light scatterer are made of ultraviolet curable resin materials.

7. The optical member according to claim 1, wherein the anisotropic light condenser includes a plurality of prisms aligned in the light condensing direction, the prisms protruding from the light-receiving surface and each having a substantially mountain shape in a cross-sectional view along the light-condensing direction, the prisms extending in a straight line in the non-light condensing direction.

8. The optical member according to claim 1, wherein the anisotropic light scatterer includes a plurality of microlenses arranged in the non-light condensing direction and the light condensing direction, the microlenses protruding from the light-emitting surface of the base member and each having a substantially elliptical shape in a plan view with long axis direction thereof matching the non-light condensing direction and a short axis direction thereof matching the light condensing direction.

9. The optical member according to claim 8, wherein the plurality of microlenses are formed such that at least one of a plan view size and a height thereof is set randomly.

10. The optical member according to claim 1, wherein the base member, the anisotropic light condenser and the anisotropic light scatterer are formed integrally of a thermoplastic resin material.

11. An illumination device, comprising:
the optical member according to claim 1;
a light source; and
a light guide plate having a light-receiving face into which light from the light source enters, and a light-emitting surface from which light is emitted, the light-emitting surface facing the light-receiving surface of the optical member.

12. The illumination device according to claim 11,
wherein the anisotropic light condenser has a plurality of prisms aligned in a direction of alignment of the light source and the light guide plate, the prisms being formed on the light-receiving surface of the optical member and each having a substantially mountain shape with a pair of inclined faces in a cross-sectional view along said direction of alignment, the prisms extending in a straight line along a direction perpendicular to said direction of alignment, and
wherein, of the pair of inclined faces of each of the prisms, an inclined face opposite to the inclined face towards the light source is a curve or a polygonal line in a cross-sectional view.

13. A display device, comprising:
the illumination device according to claim 11; and
a display panel that performs display using light from the illumination device.

14. The display device according to claim 13, wherein the display panel is a liquid crystal panel including a pair of substrates with liquid crystal sealed therebetween.
